(19) United States
(12) Patent Application Publication
(10) Pub. No.: US 2026/0098462 A1
(43) Pub. Date: Apr. 9, 2026

(54) Methods for Hydrocarbon Recovery from Unconventional Formations

(71) Applicant: CHEVRON U.S.A. INC., San Ramon, CA (US)

(72) Inventors: Devesh KUMAR, Houston, TX (US); Dengen ZHOU, Sugar Land, TX (US); Mohsen Siyed TAGAVIFAR, Houston, TX (US); Sophany THACH, San Ramon, CA (US); Lee Spencer MATHIS, The Woodlands, TX (US); Kenneth Wayne GRIFFIN, Midland, TX (US); Pavarit TRAKULHOON, Midland, TX (US); Wee Yong GAN, Midland, TX (US); Cecil Dwight ALWORTH, II, Midland, TX (US); Mayank SRIVASTAVA, Houston, TX (US)

(21) Appl. No.: 19/352,012

(22) Filed: Oct. 7, 2025

Related U.S. Application Data
(60) Provisional application No. 63/704,504, filed on Oct. 7, 2024.

(51) Int. Cl. E21B 43/16; C09K 8/594

(52) U.S. Cl. CPC E21B 43/166; C09K 8/594

(57) ABSTRACT

Described herein are methods for hydrocarbon recovery from an unconventional subterranean formation having a wellbore in fluid communication therewith. These methods can include: injecting a volume of an aqueous solution through the wellbore into the unconventional subterranean formation between injections of a volume of a first gas and a volume of a second gas through the wellbore into the unconventional subterranean formation; and producing fluids from the unconventional subterranean formation through the wellbore. In some embodiments, a sum of the volume of the first gas and the volume of the second gas equals to a total gas volume; and a ratio of the total gas volume (in SCF) to the volume of the aqueous solution (in BBL) is from 1,750:1 to 10,000:1.

### CROSS-REFERENCE TO RELATED APPLICATION

This application claims priority to, and the benefit of U.S. Provisional Application 63/704,504, filed on Oct. 7, 2024, the contents of which is hereby incorporated in its entirety.

### BACKGROUND

As wells age, multiple mechanisms may contribute to the production decline. The compositions and methods disclosed herein address these and other needs.

### SUMMARY

Described herein are methods for hydrocarbon recovery from an unconventional subterranean formation having a wellbore in fluid communication therewith. These methods can include: injecting a volume of an aqueous solution through the wellbore into the unconventional subterranean formation between injections of a volume of a first gas and a volume of a second gas through the wellbore into the unconventional subterranean formation; and producing fluids from the unconventional subterranean formation through the wellbore. In some embodiments, a sum of the volume of the first gas and the volume of the second gas equals to a total gas volume; and a ratio of the total gas volume (in SCF) to the volume of the aqueous solution (in BBL) is from 1,750:1 to 10,000:1.

Also described herein are methods for hydrocarbon recovery from an unconventional subterranean formation having a wellbore in fluid communication therewith that include: co-injecting a volume of an aqueous solution and a volume of a gas through the wellbore into the unconventional subterranean formation; and producing fluids from the unconventional subterranean formation through the wellbore. In some embodiments, a ratio of the volume of the gas (in SCF) to the volume of the aqueous solution (in BBL) is from 1,750:1 to 10,000:1.

Also described herein are methods for hydrocarbon recovery from an unconventional subterranean formation having a wellbore in fluid communication therewith that include: injecting a volume of a first gas through the wellbore into the unconventional subterranean formation; co-injecting a volume of an aqueous solution and a volume of a second gas through the wellbore into the unconventional subterranean formation; and producing fluids from the unconventional subterranean formation through the wellbore. In some embodiments, a sum of the volume of the first gas and the volume of the second gas equals to a total gas volume; and

wherein a ratio of the total gas volume (in SCF) to the volume of the aqueous solution (in BBL) is from 1,750:1 to 10,000:1.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is an illustration of gas enhanced oil recovery.

FIG. 2 is an illustration of challenges in gas EOR operations.

FIG. 3 is an illustration of water alternating gas (WAG) trapping injected gas.

FIG. 4A-4D are graph showing data of water alternating gas (WAG) trapping injected gas.

FIG. 5 is an illustration of surfactant alternating gas (SAG).

FIG. 6A-6C are graph showing data of surfactant alternating gas (SAG).

FIG. 7 is an illustration of adding more potent injected gas (propane and butanes) to the injected gas.

FIG. 8 is a graph showing WAG has sustained oil uplift. Water helps in trapping the injected gas: better mixing and long-lasting oil uplift.

FIG. 9A-9D are a graphs showing WAG has sustained oil uplift and bottom hole pressure. (9A) oil, (9B) gas, (9C) water, and (9D) BHP. Water helps in trapping the injected gas: better mixing and long-lasting oil uplift.

FIG. 10 is an illustration of WAG. Water after gas injection traps gas in matrix leading to less gas flowback leading to more mixing

FIG. 11A-11B is a graph showing simulation results for a mechanistic model WAG hysteresis. Hysteresis simulates the trapped gas during WAG.

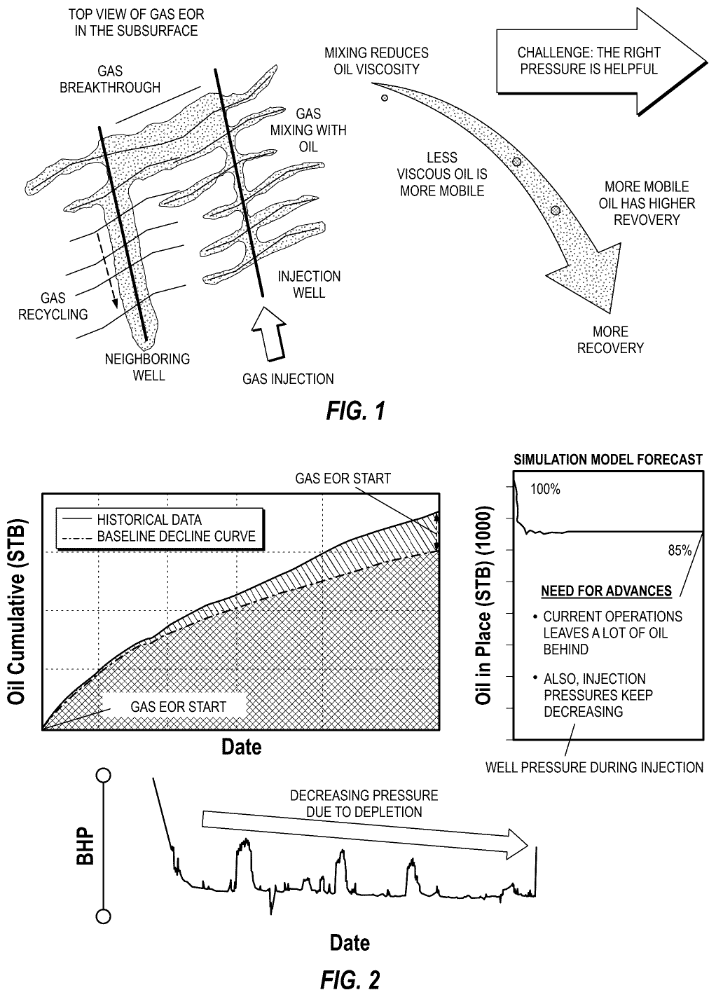

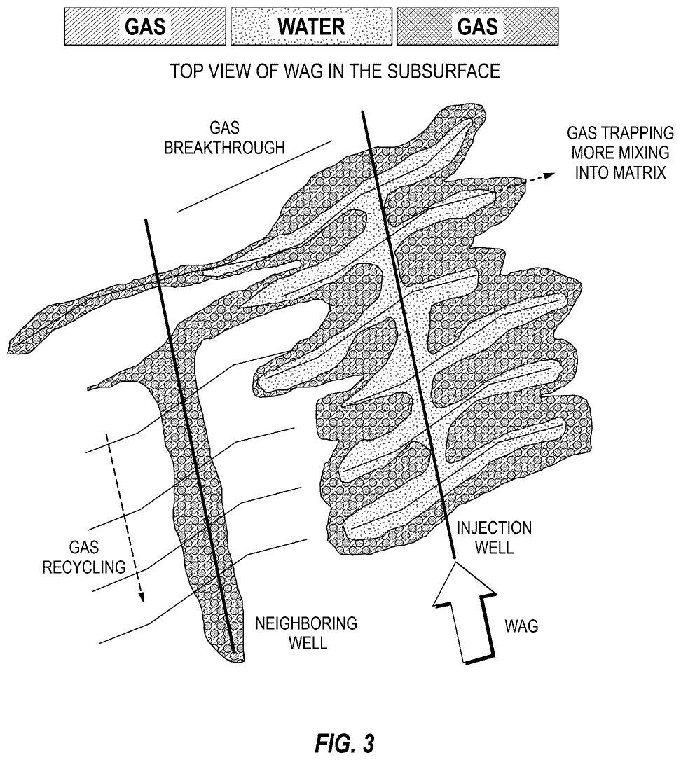

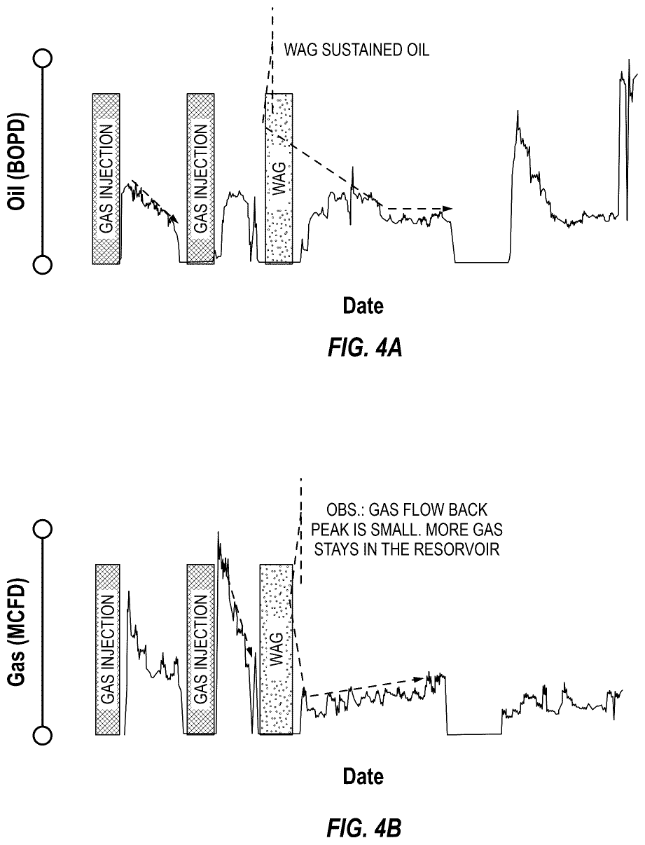

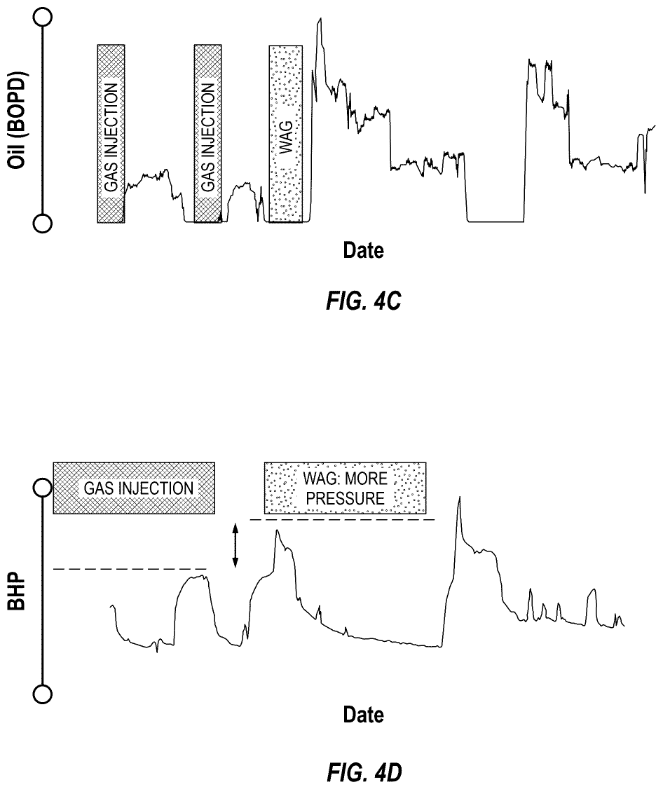

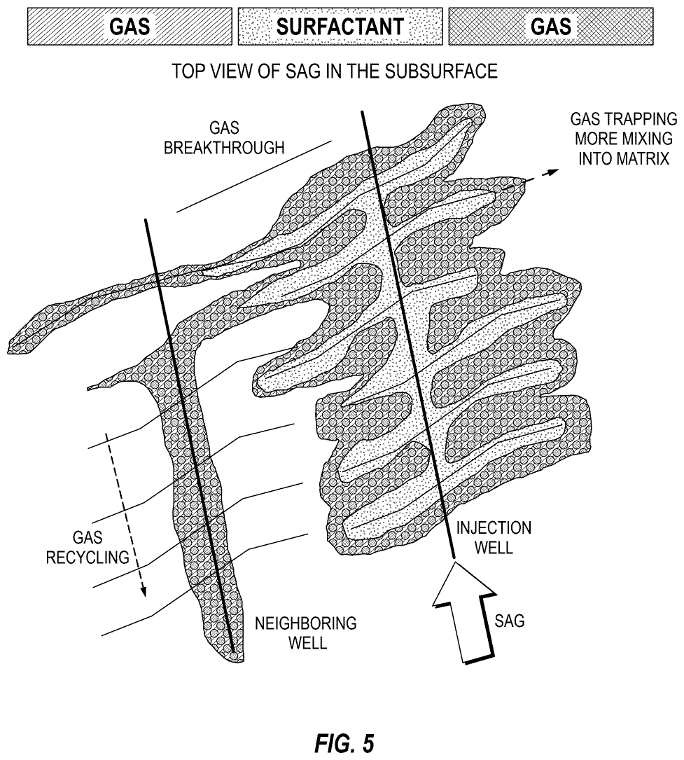

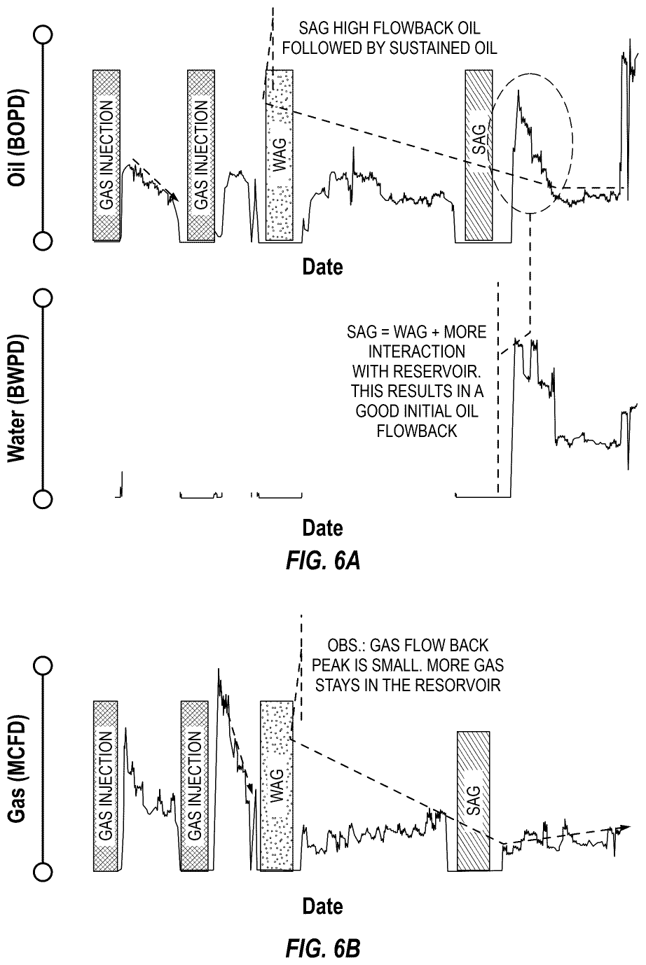

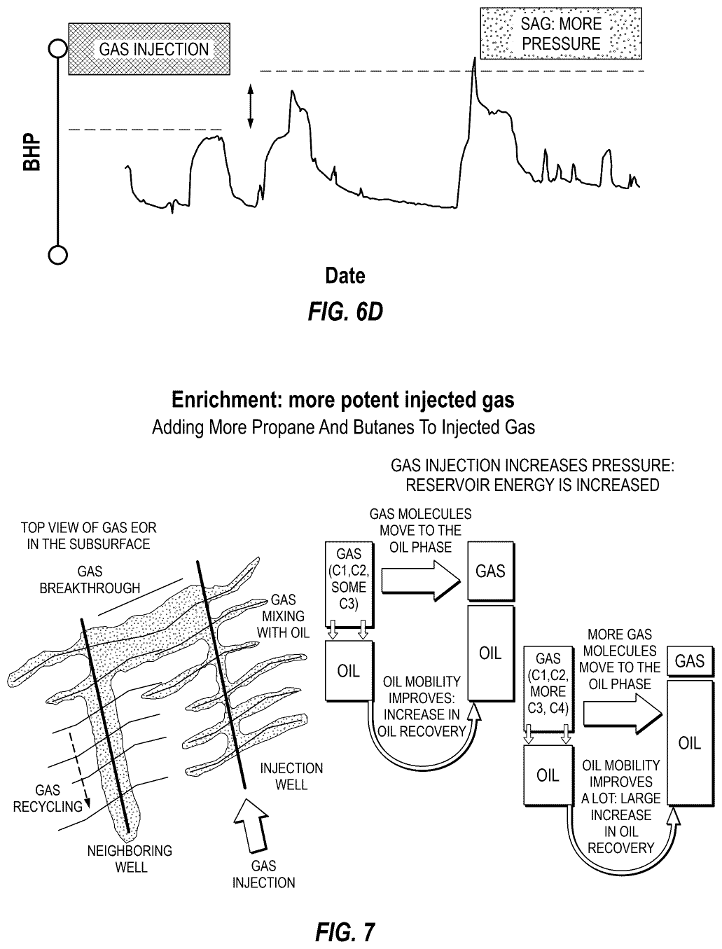

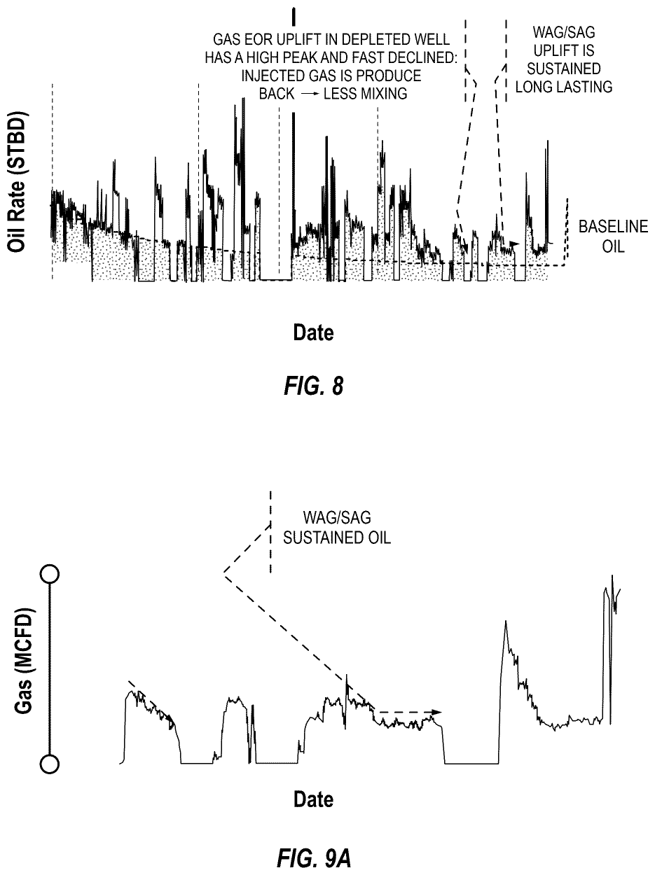

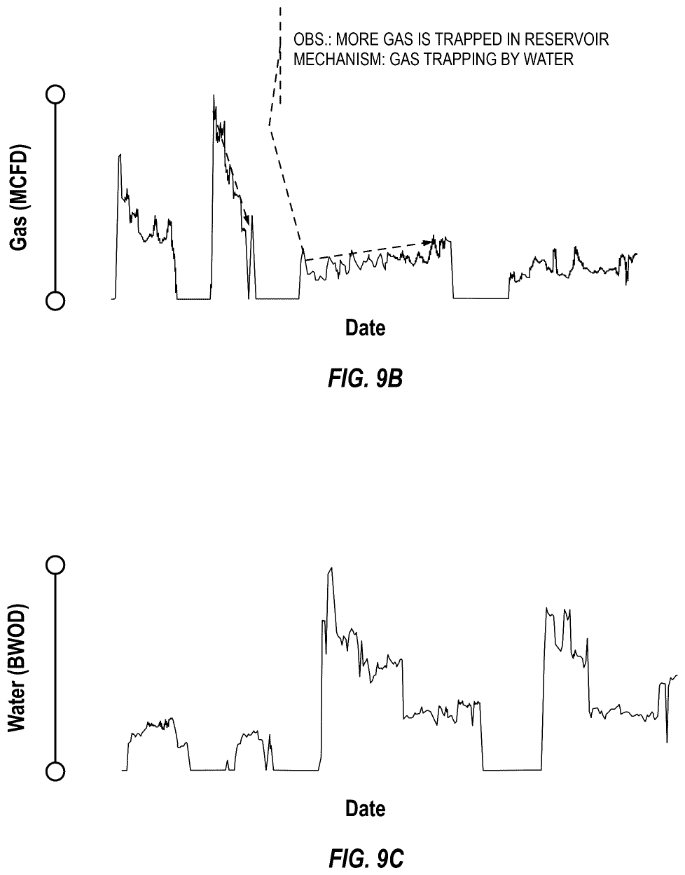

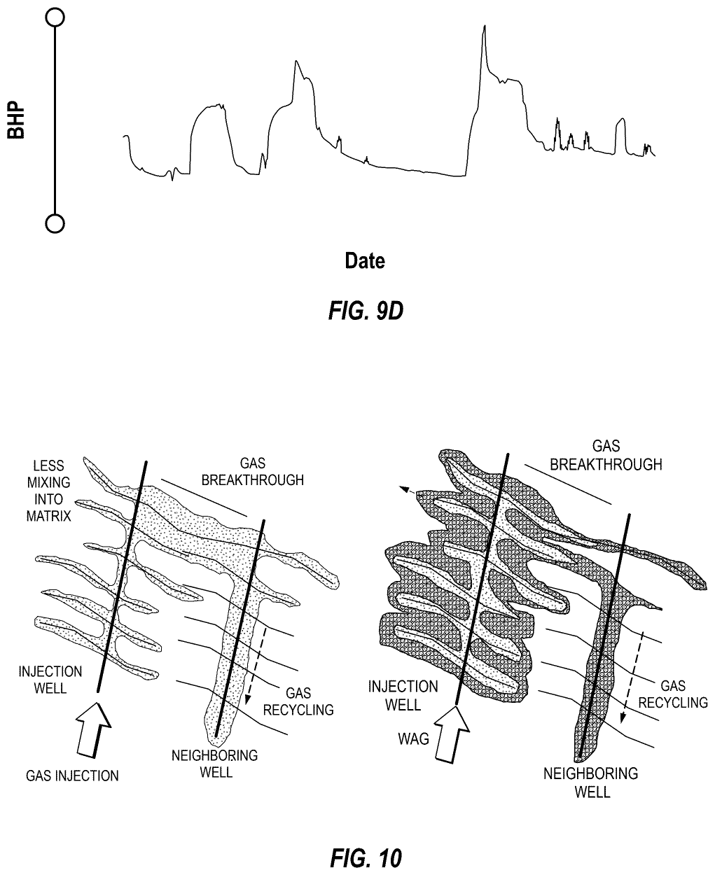

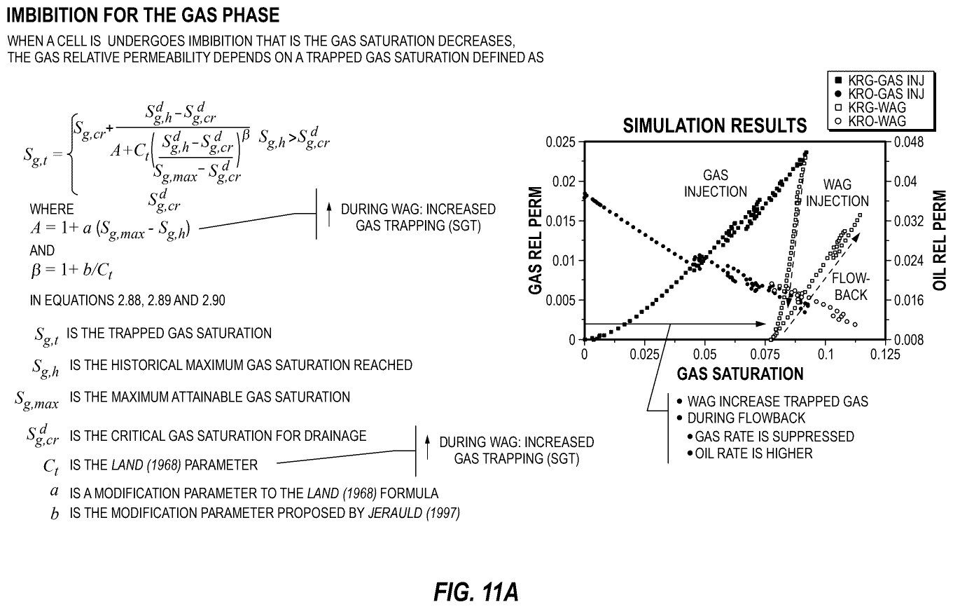

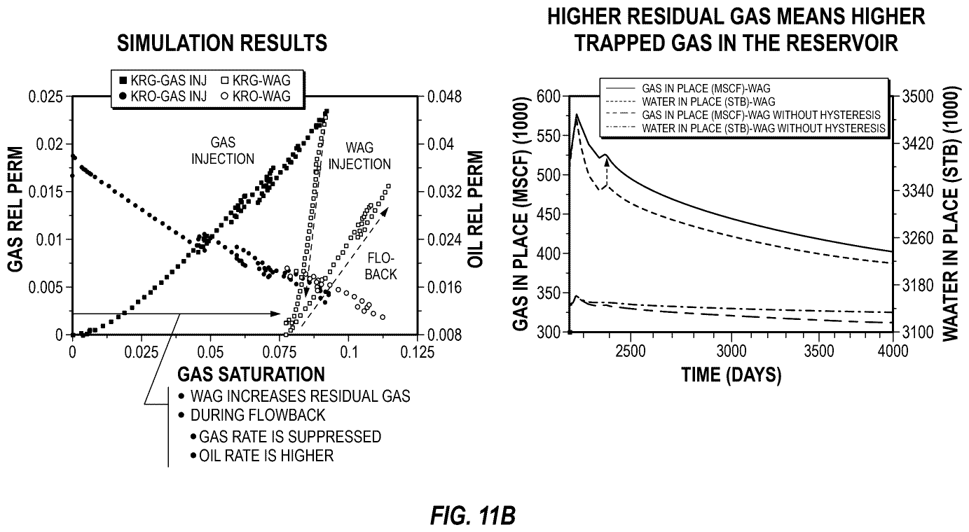

Like reference symbols in the various drawings indicate like elements.

### DETAILED DESCRIPTION

A number of embodiments of the disclosure have been described. Nevertheless, it will be understood that various modifications may be made without departing from the spirit and scope of the invention. Accordingly, other embodiments are within the scope of the following claims.

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs. Unless otherwise specified, all percentages are in weight percent and the pressure is in atmospheres. All citations referred to herein are expressly incorporated by reference.

### General Definitions

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Ranges can be expressed herein as from “about” one particular value, and/or to “about” another particular value. By “about” is meant within 10% of the value, e.g., within 9, 8, 7, 6, 5, 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. A range may be construed to include the start and the end of the range. For example, a range of 10% to 20% (i.e., range of 10%-20%) can includes 10% and also includes 20%, and includes percentages in between 10% and 20%, unless explicitly stated otherwise herein.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if a composition is described herein as including a component of type A, a component of type B, a component of type C, or any combination thereof, it is understood that this phrase describes all of the various individual and collective combinations and permutations of these components. For example, in some embodiments, the composition described by this phrase could include only a component of type A. In some embodiments, the composition described by this phrase could include only a component of type B. In some embodiments, the composition described by this phrase could include only a component of type C. In some embodiments, the composition described by this phrase could include a component of type A and a component of type B. In some embodiments, the composition described by this phrase could include a component of type A and a component of type C. In some embodiments, the composition described by this phrase could include a component of type B and a component of type C. In some embodiments, the composition described by this phrase could include a component of type A, a component of type B, and a component of type C. In some embodiments, the composition described by this phrase could include two or more components of type A (e.g., A1 and A2). In some embodiments, the composition described by this phrase could include two or more components of type B (e.g., B1 and B2). In some embodiments, the composition described by this phrase could include two or more components of type C (e.g., C1 and C2). In some embodiments, the composition described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the composition described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the composition described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

The term “hydrocarbon” refers to a compound containing only carbon and hydrogen atoms.

“Hydrocarbon-bearing formation” or simply “formation” refers to the rock matrix in which a wellbore may be drilled. For example, a formation refers to a body of rock that is sufficiently distinctive and continuous such that it can be mapped. It should be appreciated that while the term “formation” generally refers to geologic formations of interest, that the term “formation,” as used herein, may, in some instances, include any geologic points or volumes of interest (such as a survey area).

“Unconventional formation” is a subterranean hydrocarbon-bearing formation that generally requires intervention in order to recover hydrocarbons from the reservoir at economic flow rates or volumes. For example, an unconventional formation includes reservoirs having an unconventional microstructure in which fractures are used to recover hydrocarbons from the reservoir at sufficient flow rates or volumes (e.g., an unconventional reservoir generally needs to be fractured under pressure or have naturally occurring fractures in order to recover hydrocarbons from the reservoir at sufficient flow rates or volumes).

In some embodiments, the unconventional formation can include a reservoir having a permeability of less than 25 millidarcy (mD) (e.g., 20 mD or less, 15 mD or less, 10 mD or less, 5 mD or less, 1 mD or less, 0.5 mD or less, 0.1 mD or less, 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, 0.000001 mD or less, or less). In some embodiments, the unconventional formation can include a reservoir having a permeability of at least 0.000001 mD (e.g., at least 0.000005 mD, at least 0.00001 mD, 0.00005 mD, at least 0.0001 mD, 0.0005 mD, 0.001 mD, at least 0.005 mD, at least 0.01 mD, at least 0.05 mD, at least 0.1 mD, at least 0.5 mD, at least 1 mD, at least 5 mD, at least 10 mD, at least 15 mD, or at least 20 mD).

The unconventional formation can include a reservoir having a permeability ranging from any of the minimum values described above to any of the maximum values described above. For example, in some embodiments, the unconventional formation can include a reservoir having a permeability of from 0.000001 mD to 25 mD (e.g., from 0.001 mD to 25 mD, from 0.001 mD to 10 mD, from 0.01 mD to 10 mD, from 0.1 mD to 10 mD, from 0.001 mD to 5 mD, from 0.01 mD to 5 mD, or from 0.1 mD to 5 mD). The permeability of a particular formation can be determined by averaging measured permeability values from a series of representative core samples obtained from the formation. Shale formations typically have permeabilities on the order of microdarcy (μD) to nanodarcy (nD).

The formation may include faults, fractures (e.g., naturally occurring fractures, fractures created through hydraulic fracturing, etc.), geobodies, overburdens, underburdens, horizons, salts, salt welds, etc. The formation may be onshore, offshore (e.g., shallow water, deep water, etc.), etc. Furthermore, the formation may include hydrocarbons, such as liquid hydrocarbons (also known as oil or petroleum), gas hydrocarbons, a combination of liquid hydrocarbons and gas hydrocarbons (e.g., including gas condensate), etc.

The formation, the hydrocarbons, or both may also include non-hydrocarbon items, such as pore space, connate water, brine, fluids from enhanced oil recovery, etc. The formation may also be divided up into one or more hydrocarbon zones, and hydrocarbons can be produced from each desired hydrocarbon zone.

The term formation may be used synonymously with the term “reservoir” or “subsurface reservoir” or “subsurface region of interest” or “subsurface formation” or “subsurface volume of interest” or “subterranean formation”. For example, in some embodiments, the reservoir may be, but is not limited to, a shale reservoir, a carbonate reservoir, a tight sandstone reservoir, a tight siltstone reservoir, etc. Indeed, the terms “formation,” “hydrocarbon,” and the like are not limited to any description or configuration described herein.

A “wellbore” refers to a single hole, usually cylindrical, that is drilled into a subsurface volume of interest. A wellbore may be drilled in one or more directions. For example, a wellbore may include a vertical wellbore, a horizontal wellbore, a deviated wellbore, and/or other type of wellbore. A wellbore may be drilled in the formation for exploration and/or recovery of resources. For example, a wellbore may be drilled in the formation to aid in extraction and/or production of resources such as hydrocarbons. As another example, a wellbore may be drilled in the formation for fluid injection. A plurality of wellbores (e.g., tens to hundreds of wellbores) are often used in a field depending on the desired outcome.

A wellbore may be drilled into a formation using practically any drilling technique and equipment known in the art, such as geosteering, directional drilling, etc. Drilling the wellbore may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling (SWD) tools, wireline tools, logging-while-drilling (LWD) tools, or other downhole tools. After drilling to a predetermined depth, the drill string and the drill bit may be removed, and then the casing, the tubing, and/or other equipment may be installed according to the design of the wellbore may be installed according to the design of the wellbore. The equipment to be used in drilling the wellbore may be dependent on the design of the wellbore, the formation, the hydrocarbons, and/or other factors.

A wellbore may include a plurality of components, such as, but not limited to, a casing, a liner, a tubing string, a sensor, a packer, a screen, a gravel pack, artificial lift equipment (e.g., an electric submersible pump (ESP)), and/or other components. If a wellbore is drilled offshore, the wellbore may include one or more of the previous components plus other offshore components, such as a riser. A wellbore may also include equipment to control fluid flow into the wellbore, control fluid flow out of the wellbore, or any combination thereof. For example, a wellbore may include a wellhead, a choke, a valve, and/or other control devices. These control devices may be located on the surface, in the subsurface (e.g., downhole in the wellbore), or any combination thereof. In some embodiments, the same control devices may be used to control fluid flow into and out of the wellbore. In some embodiments, different control devices may be used to control fluid flow into and out of a wellbore. In some embodiments, the rate of flow of fluids through the wellbore may depend on the fluid handling capacities of the surface facility that is in fluidic communication with the wellbore. The equipment to be used in controlling fluid flow into and out of a wellbore may be dependent on the wellbore, the formation, the surface facility, and/or other factors. Moreover, sand control equipment and/or sand monitoring equipment may also be installed (e.g., downhole and/or on the surface). A wellbore may also include any completion hardware that is not discussed separately. The term “wellbore” may be used synonymously with the terms “borehole,” “well,” or “well bore.” The term “wellbore” is not limited to any description or configuration described herein.

The term “interfacial tension” or “IFT” as used herein refers to the surface tension between test oil and water of different salinities containing a surfactant formulation at different concentrations. Typically, interfacial tensions are measured using a spinning drop tensiometer or calculated from phase behavior experiments.

The term “proximate” is defined as “near”. If item A is proximate to item B, then item A is near item B. For example, in some embodiments, item A may be in contact with item B. For example, in some embodiments, there may be at least one barrier between item A and item B such that item A and item B are near each other, but not in contact with each other. The barrier may be a fluid barrier, a non-fluid barrier (e.g., a structural barrier), or any combination thereof. Both scenarios are contemplated within the meaning of the term “proximate.”

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e., organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) (i.e., API gravity) and market price in comparison to light (or sweet) crude oils. Crude oil may also be characterized by its Equivalent Alkane Carbon Number (EACN). The term “API gravity” refers to the measure of how heavy or light a petroleum liquid is compared to water. If an oil's API gravity is greater than 10, it is lighter and floats on water, whereas if it is less than 10, it is heavier and sinks. API gravity is thus an inverse measure of the relative density of a petroleum liquid and the density of water. API gravity may also be used to compare the relative densities of petroleum liquids. For example, if one petroleum liquid floats on another and is therefore less dense, it has a greater API gravity.

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin-based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are sensitive to temperature changes than the paraffin-based crudes. (iii) Mixed based crude oils contain both paraffin and naphthenes, as well as aromatic hydrocarbons. Most crude oils fit this latter category.

“Reactive” crude oil, as referred to herein, is crude oil containing natural organic acidic components (also referred to herein as unrefined petroleum acid) or their precursors such as esters or lactones. These reactive crude oils can generate soaps (carboxylates) when reacted with alkali. More terms used interchangeably for crude oil throughout this disclosure are hydrocarbons, hydrocarbon material, or active petroleum material. An “oil bank” or “oil cut” as referred to herein, is the crude oil that does not contain the injected chemicals and is pushed by the injected fluid during an enhanced oil recovery process. A “nonactive oil,” as used herein, refers to an oil that is not substantially reactive or crude oil not containing significant amounts of natural organic acidic components or their precursors such as esters or lactones such that significant amounts of soaps are generated when reacted with alkali. A nonactive oil as referred to herein includes oils having an acid number of less than 0.5 mg KOH/g of oil.

“Unrefined petroleum acids” as referred to herein are carboxylic acids contained in active petroleum material (reactive crude oil). The unrefined petroleum acids contain C₁₁-C₂₀ alkyl chains, including napthenic acid mixtures. The recovery of such “reactive” oils may be performed using alkali (e.g., NaOH, NaHCO₃, or Na₂CO₃) in a surfactant composition. The alkali reacts with the acid in the reactive oil to form soap in situ. These in situ generated soaps serve as a source of surfactants minimizing the levels of added surfactants, thus enabling efficient oil recovery from the reservoir.

The term “polymer” refers to a molecule having a structure that essentially includes the multiple repetitions of units derived, actually or conceptually, from molecules of low relative molecular mass. In some embodiments, the polymer is an oligomer.

The term “productivity” as applied to a petroleum or oil well refers to the capacity of a well to produce hydrocarbons (e.g., unrefined petroleum); that is, the ratio of the hydrocarbon flow rate to the pressure drop, where the pressure drop is the difference between the average reservoir pressure and the flowing bottom hole well pressure (i.e., flow per unit of driving force).

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. More generally, the less viscous a fluid is, the greater its ease of fluidity.

The term “salinity” as used herein, refers to concentration of salt dissolved in an aqueous phase. Examples for such salts are without limitation, sodium chloride, magnesium and calcium sulfates, and bicarbonates. In particular, the term salinity as it pertains to the present invention refers to the concentration of salts in brine and surfactant solutions.

Unless defined otherwise, all technical and scientific terms used herein have the same meanings as commonly understood by one of skill in the art to which the disclosed invention belongs. Unless otherwise specified, all percentages are in weight percent and the pressure is in atmospheres.

“Friction reducer,” as used herein, refers to a chemical additive that alters fluid rheological properties to reduce friction created within the fluid as it flows through small-diameter tubulars or similar restrictions (e.g., valves, pumps). Generally polymers, or similar friction reducing agents, add viscosity to the fluid, which reduces the turbulence induced as the fluid flows. Reductions in fluid friction of greater than 50% are possible depending on the friction reducer utilized, which allows the injection fluid to be injected into a wellbore at a much higher injection rate (e.g., between 60 to 100 barrels per minute) and also lower pumping pressure during proppant injection.

“Injection fluid,” as used herein, refers to any fluid which is injected into a reservoir via a well. “Fracturing fluid,” as used herein, refers to an injection fluid that is injected into the well under pressure in order to cause fracturing within a portion of the reservoir.

Unless defined otherwise, all technical and scientific terms used herein have the same meanings as commonly understood by one of skill in the art to which the disclosed invention belongs. Unless otherwise specified, all percentages are in weight percent and the pressure is in atmospheres

Reference will now be made in detail to specific aspects of the disclosed materials, compounds, compositions, articles, and methods, examples of which are illustrated in the accompanying Examples and Figures.

### METHODS

Described herein are methods for hydrocarbon recovery from an unconventional subterranean formation having a wellbore in fluid communication therewith. These methods can include: injecting a volume of an aqueous solution through the wellbore into the unconventional subterranean formation between injections of a volume of a first gas and a volume of a second gas through the wellbore into the unconventional subterranean formation; and producing fluids from the unconventional subterranean formation through the wellbore. In some embodiments, a sum of the volume of the first gas and the volume of the second gas equals to a total gas volume.

Also described herein are methods for hydrocarbon recovery from an unconventional subterranean formation having a wellbore in fluid communication therewith that include: injecting a volume of a first gas through the wellbore into the unconventional subterranean formation; co-injecting a volume of an aqueous solution and a volume of a second gas through the wellbore into the unconventional subterranean formation; and producing fluids from the unconventional subterranean formation through the wellbore. In some embodiments, a sum of the volume of the first gas and the volume of the second gas equals to a total gas volume.

In some embodiments, a ratio of the volume of the total gas (in SCF) to the volume of the aqueous solution (in BBL) is at least 1,750:1 (e.g., at least 2,000:1, at least 2,250:1, at least 2,500:1, at least 3,000:1, at least 3,500:1, at least 4,000:1, at least 4,500:1, at least 5,000:1, at least 5,500:1, at least 6,000:1, at least 6,500:1, at least 7,000:1, at least 7,500:1, at least 8,000:1, at least 8,500:1, at least 9,000:1, or at least 9,500:1).

In some embodiments, a ratio of the volume of the total gas (in SCF) to the volume of the aqueous solution (in BBL) is 10,000:1 or less (e.g., 9,500:1 or less, 9,000:1 or less, 8,500:1 or less, 8,000:1 or less, 7,500:1 or less, 7,000:1 or less, 6,500:1 or less, 6,000:1 or less, 5,500:1 or less, 5,000:1 or less, 4,500:1 or less, 4,000:1 or less, 3,500:1 or less, 3,000:1 or less, 2,500:1 or less, or 2,000:1 or less).

A ratio of the volume of the total gas (in SCF) to the volume of the aqueous solution (in BBL) can range from any of the minimum values described above to any of the maximum values described above. For example, in some embodiments, a ratio of the volume of the gas (in SCF) to the volume of the aqueous solution (in BBL) is from 1,750:1 to 10,000:1 (e.g., from 3,000:1 to 10,000:1, from 5,000:1 to 10,000:1, or from 7,500:1 to 10,000:1).

In some embodiments, the total gas volume can be of at least 100 million SCF (e.g., at least 150 million SCF, at least 200 million SCF, at least 250 million SCF, at least 300 million SCF, at least 350 million SCF, at least 400 million SCF, at least 450 million SCF, at least 500 million SCF, at least 550 million SCF, at least 600 million SCF, at least 650 million SCF, or at least 700 million SCF).

In some embodiments, the total gas volume can be of 750 million SCF or less (e.g., 700 million SCF or less, 650 million SCF or less, 600 million SCF or less, 550 million SCF or less, 500 million SCF or less, 450 million SCF or less, 400 million SCF or less, 350 million SCF or less, 300 million SCF or less, 250 million SCF or less, 200 million SCF or less, or 150 million SCF or less).

The total gas volume can range from any of the minimum values described above to any of the maximum values described above. For example, in some embodiments, the total gas volume can be from 100 million SCF to 750 million SCF (e.g., from 150 million SCF to 750 million SCF, from 200 million SCF to 750 million SCF, from 250 million SCF to 750 million SCF, from 300 million SCF to 750 million SCF, from 350 million SCF to 750 million SCF, from 400 million SCF to 750 million SCF, from 450 million SCF to 750 million SCF, from 500 million SCF to 750 million SCF, from 550 million SCF to 750 million SCF, from 600 million SCF to 750 million SCF, from 650 million SCF to 750 million SCF, from 700 million SCF to 750 million SCF, from 100 million SCF to 700 million SCF, from 150 million SCF to 700 million SCF, from 200 million SCF to 700 million SCF, from 250 million SCF to 700 million SCF, from 300 million SCF to 700 million SCF, from 350 million SCF to 700 million SCF, from 400 million SCF to 700 million SCF, from 450 million SCF to 700 million SCF, from 500 million SCF to 700 million SCF, from 550 million SCF to 700 million SCF, from 600 million SCF to 700 million SCF, from 650 million SCF to 700 million SCF, from 100 million SCF to 600 million SCF, from 150 million SCF to 600 million SCF, from 200 million SCF to 600 million SCF, from 250 million SCF to 600 million SCF, from 300 million SCF to 600 million SCF, from 350 million SCF to 600 million SCF, from 400 million SCF to 600 million SCF, from 450 million SCF to 600 million SCF, from 500 million SCF to 600 million SCF, from 100 million SCF to 500 million SCF, from 150 million SCF to 500 million SCF, from 200 million SCF to 500 million SCF, from 250 million SCF to 500 million SCF, from 300 million SCF to 500 million SCF, from 350 million SCF to 500 million SCF, from 400 million SCF to 500 million SCF, from 100 million SCF to 400 million SCF, from 150 million SCF to 400 million SCF, from 200 million SCF to 400 million SCF, from 250 million SCF to 400 million SCF, from 300 million SCF to 400 million SCF, from 350 million SCF to 400 million SCF, from 100 million SCF to 300 million SCF, from 150 million SCF to 300 million SCF, from 200 million SCF to 300 million SCF, from 100 million SCF to 200 million SCF, or from 150 million SCF to 200 million SCF).

In some embodiments, the first gas and the second gas can be present in a ratio of the first gas to the second gas of at least 0.25:1 (e.g., at least 0.3:1, at least 0.4:1, at least 0.5:1, at least 0.6:1, at least 0.7:1, at least 0.8:1, or at least 0.9:1). In some embodiments, the first gas and the second gas can be present in a ratio of the first gas to the second gas of 1.5:1 or less (e.g., 1.5:1 or less, 1.25:1 or less, 1.2:1 or less, 1.15:1 or less, 1.10:1 or less, or 1.05:1 or less).

The first gas and the second gas can be present in a ratio of the first gas to the second gas ranging from any of the minimum values described above to any of the maximum values described above. For example, in some embodiments, the first gas and the second gas can be present in a ratio of the first gas to the second gas of from 0.25:1 to 1.5:1 (e.g., from 0.5:1 to 1.5:1, from 0.5:1 to 1:1, or from 1:1 to 1.5:1).

Also described herein are methods for hydrocarbon recovery from an unconventional subterranean formation having a wellbore in fluid communication therewith that include: co-injecting a volume of an aqueous solution and a volume of a gas through the wellbore into the unconventional subterranean formation; and producing fluids from the unconventional subterranean formation through the wellbore.

In some embodiments, a ratio of the volume of the gas (in SCF) to the volume of the aqueous solution (in BBL) is at least 1,750:1 (e.g., at least 2,000:1, at least 2,250:1, at least 2,500:1, at least 3,000:1, at least 3,500:1, at least 4,000:1, at least 4,500:1, at least 5,000:1, at least 5,500:1, at least 6,000:1, at least 6,500:1, at least 7,000:1, at least 7,500:1, at least 8,000:1, at least 8,500:1, at least 9,000:1, or at least 9,500:1).

In some embodiments, a ratio of the volume of the gas (in SCF) to the volume of the aqueous solution (in BBL) is 10,000:1 or less (e.g., 9,500:1 or less, 9,000:1 or less, 8,500:1 or less, 8,000:1 or less, 7,500:1 or less, 7,000:1 or less, 6,500:1 or less, 6,000:1 or less, 5,500:1 or less, 5,000:1 or less, 4,500:1 or less, 4,000:1 or less, 3,500:1 or less, 3,000:1 or less, 2,500:1 or less, or 2,000:1 or less).

A ratio of the volume of the gas (in SCF) to the volume of the aqueous solution (in BBL) can range from any of the minimum values described above to any of the maximum values described above. For example, in some embodiments, a ratio of the volume of the gas (in SCF) to the volume of the aqueous solution (in BBL) is from 1,750:1 to 10,000:1 (e.g., from 3,000:1 to 10,000:1, from 5,000:1 to 10,000:1, or from 7,500:1 to 10,000:1).

In some embodiments, the gas volume can be of at least 100 million SCF (e.g., at least 150 million SCF, at least 200 million SCF, at least 250 million SCF, at least 300 million SCF, at least 350 million SCF, at least 400 million SCF, at least 450 million SCF, at least 500 million SCF, at least 550 million SCF, at least 600 million SCF, at least 650 million SCF, or at least 700 million SCF).

In some embodiments, the gas volume can be of 750 million SCF or less (e.g., 700 million SCF or less, 650 million SCF or less, 600 million SCF or less, 550 million SCF or less, 500 million SCF or less, 450 million SCF or less, 400 million SCF or less, 350 million SCF or less, 300 million SCF or less, 250 million SCF or less, 200 million SCF or less, or 150 million SCF or less).

The gas volume can range from any of the minimum values described above to any of the maximum values described above. For example, in some embodiments, the gas volume can be from 100 million SCF to 750 million SCF (e.g., from 150 million SCF to 750 million SCF, from 200 million SCF to 750 million SCF, from 250 million SCF to 750 million SCF, from 300 million SCF to 750 million SCF, from 350 million SCF to 750 million SCF, from 400 million SCF to 750 million SCF, from 450 million SCF to 750 million SCF, from 500 million SCF to 750 million SCF, from 550 million SCF to 750 million SCF, from 600 million SCF to 750 million SCF, from 650 million SCF to 750 million SCF, from 700 million SCF to 750 million SCF, from 100 million SCF to 700 million SCF, from 150 million SCF to 700 million SCF, from 200 million SCF to 700 million SCF, from 250 million SCF to 700 million SCF, from 300 million SCF to 700 million SCF, from 350 million SCF to 700 million SCF, from 400 million SCF to 700 million SCF, from 450 million SCF to 700 million SCF, from 500 million SCF to 700 million SCF, from 550 million SCF to 700 million SCF, from 600 million SCF to 700 million SCF, from 650 million SCF to 700 million SCF, from 100 million SCF to 600 million SCF, from 150 million SCF to 600 million SCF, from 200 million SCF to 600 million SCF, from 250 million SCF to 600 million SCF, from 300 million SCF to 600 million SCF, from 350 million SCF to 600 million SCF, from 400 million SCF to 600 million SCF, from 450 million SCF to 600 million SCF, from 500 million SCF to 600 million SCF, from 100 million SCF to 500 million SCF, from 150 million SCF to 500 million SCF, from 200 million SCF to 500 million SCF, from 250 million SCF to 500 million SCF, from 300 million SCF to 500 million SCF, from 350 million SCF to 500 million SCF, from 400 million SCF to 500 million SCF, from 100 million SCF to 400 million SCF, from 150 million SCF to 400 million SCF, from 200 million SCF to 400 million SCF, from 250 million SCF to 400 million SCF, from 300 million SCF to 400 million SCF, from 350 million SCF to 400 million SCF, from 100 million SCF to 300 million SCF, from 150 million SCF to 300 million SCF, from 200 million SCF to 300 million SCF, from 100 million SCF to 200 million SCF, or from 150 million SCF to 200 million SCF).

In some embodiments, the volume of the aqueous solution injected and/or co-injected can be of at least 5% of the estimated SRV (e.g., at least 10% of the estimated SRV, at least 15% of the estimated SRV, at least 20% of the estimated SRV, at least 25% of the estimated SRV, at least 30% of the estimated SRV, at least 35% of the estimated SRV, at least 40% of the estimated SRV, at least 45% of the estimated SRV, at least 50% of the estimated SRV, at least 55% of the estimated SRV, at least 60% of the estimated SRV, or at least 65% of the estimated SRV). In some embodiments, the volume of the aqueous solution injected and/or co-injected can be of 70% of the estimated SRV or less (e.g., 65% of the estimated SRV or less, 60% of the estimated SRV or less, 55% of the estimated SRV or less, 50% of the estimated SRV or less, 45% of the estimated SRV or less, 40% of the estimated SRV or less, 35% of the estimated SRV or less, 30% of the estimated SRV or less, 25% of the estimated SRV or less, 20% of the estimated SRV or less, 15% of the estimated SRV or less, or 10% of the estimated SRV or less).

The volume of the aqueous solution injected and/or co-injected can be ranging from any of the minimum values described above to any of the maximum values described above. For example, in some embodiments, the volume of the aqueous solution injected and/or co-injected can be of from 5% of the estimated SRV to 70% of the estimated SRV (e.g., from 10% of the estimated SRV to 70% of the estimated SRV, from 20% of the estimated SRV to 70% of the estimated SRV, from 30% of the estimated SRV to 70% of the estimated SRV, from 40% of the estimated SRV to 70% of the estimated SRV, from 50% of the estimated SRV to 70% of the estimated SRV, from 60% of the estimated SRV to 70% of the estimated SRV, from 5% of the estimated SRV to 60% of the estimated SRV, from 10% of the estimated SRV to 60% of the estimated SRV, from 20% of the estimated SRV to 60% of the estimated SRV, from 30% of the estimated SRV to 60% of the estimated SRV, from 40% of the estimated SRV to 60% of the estimated SRV, from 50% of the estimated SRV to 60% of the estimated SRV, from 5% of the estimated SRV to 50% of the estimated SRV, from 10% of the estimated SRV to 50% of the estimated SRV, from 20% of the estimated SRV to 50% of the estimated SRV, from 30% of the estimated SRV to 50% of the estimated SRV, from 40% of the estimated SRV to 50% of the estimated SRV, from 5% of the estimated SRV to 40% of the estimated SRV, from 10% of the estimated SRV to 40% of the estimated SRV, from 20% of the estimated SRV to 40% of the estimated SRV, from 30% of the estimated SRV to 40% of the estimated SRV, from 5% of the estimated SRV to 30% of the estimated SRV, from 10% of the estimated SRV to 30% of the estimated SRV, from 20% of the estimated SRV to 30% of the estimated SRV, or from 5% of the estimated SRV to 20% of the estimated SRV, from 10% of the estimated SRV to 20% of the estimated SRV, or from 5% of the estimated SRV to 10% of the estimated SRV).

In some embodiments, the volume of the aqueous solution can be injected and/or co-injected in a volume of at least 20,000 barrels. (e.g., at least 25,000 barrels, at least 30,000 barrels, at least 35,000 barrels, at least 40,000 barrels, at least 50,000 barrels, at least 55,000 barrels, at least 60,000 barrels, at least 65,000 barrels, at least 70,000 barrels, at least 75,000 barrels, at least 80,000 barrels, at least 85,000 barrels, at least 90,000 barrels, at least 95,000 barrels, at least 100,000 barrels, or at least 125,000 barrels). In some embodiments, the volume of the aqueous solution can be injected and/or co-injected in a volume of 150,000 barrels or less (e.g., 125,000 barrels or less, 100,000 barrels or less, 75,000 barrels or less, 50,000 barrels or less, or 25,000 barrels or less).

The volume of the aqueous solution can be injected and/or co-injected in a volume ranging from any of the minimum values described above to any of the maximum values described above. For example, in some embodiments, the volume of the aqueous solution is injected in a volume of from 20,000 barrels to 150,000 barrels (e.g., 20,000 barrels to 150,000 barrels, 25,000 barrels to 150,000 barrels, 50,000 barrels to 150,000 barrels, 75,000 barrels to 150,000 barrels, 100,000 barrels to 150,000 barrels, 125,000 barrels to 150,000 barrels, 20,000 barrels to 125,000 barrels, 25,000 barrels to 125,000 barrels, 50,000 barrels to 125,000 barrels, 75,000 barrels to 125,000 barrels, 100,000 barrels to 125,000 barrels, 20,000 barrels to 100,000 barrels, 25,000 barrels to 100,000 barrels, 50,000 barrels to 100,000 barrels, 75,000 barrels to 100,000 barrels, 20,000 barrels to 75,000 barrels, 25,000 barrels to 75,000 barrels, 50,000 barrels to 75,000 barrels, 20,000 barrels to 50,000 barrels, or 25,000 barrels to 50,000 barrels).

Examples of suitable gas can include, but is not limited to, nitrogen, natural gas or a hydrocarbon component thereof, helium, CO₂, H₂S, air, or any combination thereof. In some embodiments, the gas can include a hydrocarbon component. In some embodiments, the hydrocarbon component can include methane, ethane, propane, butane, or any combination thereof. In some embodiments, the hydrocarbon component can be enriched with propane, butane, or any combination thereof.

In some embodiments, the methods can increase hydrocarbon recovery from the wellbore as compared to an expected level of hydrocarbon recovery projected from a decline curve fit to production history of the wellbore, such as using Arp's Equation.

In some embodiments, the methods can include forming an aqueous based foam in situ within the wellbore. In some embodiments, the aqueous based foam provides for conformance control.

In some embodiments, the method can further include allowing the aqueous solution to contact a rock matrix of the unconventional subterranean formation for a period of time.

The aqueous solution can be allowed to contact the rock matrix (e.g., imbibe into the rock matrix) of the unconventional subterranean formation for varying periods of time depending on the nature of the rock matrix. The contacting (imbibing) can occur during the introducing step, between the introducing and producing step, or any combination thereof. In some examples, the aqueous solution can be allowed to contact the rock matrix of the unconventional subterranean formation for at least one day (e.g., at least two days, at least three days, at least four days, at least five days, at least six days, at least one week, at least two weeks, at least three weeks, at least one month, at least two months, at least three months, at least four months, or at least five months). In some examples, the aqueous solution can be allowed to contact the rock matrix of the unconventional subterranean formation for six months or less (e.g., five months or less, four months or less, three months or less, two months or less, one month or less, three weeks or less, two weeks or less, one week or less, six days or less, five days or less, four days or less, three days or less, or two days or less).

In some embodiments, the unconventional subterranean formation can have a temperature of at least 75° F. (e.g., at least 80° F., at least 85° F., at least 90° F., at least 95° F., at least 100° F., at least 105° F., at least 110° F., at least 115° F., at least 120° F., at least 125° F., at least 130° F., at least 135° F., at least 140° F., at least 145° F., at least 150° F., at least 155° F., at least 160° F., at least 165° F., at least 170° F., at least 175° F., at least 180° F., at least 190° F., at least 200° F., at least 205° F., at least 210° F., at least 215° F., at least 220° F., at least 225° F., at least 230° F., at least 235° F., at least 240° F., at least 245° F., at least 250° F., at least 255° F., at least 260° F., at least 265° F., at least 270° F., at least 275° F., at least 280° F., at least 285° F., at least 290° F., at least 295° F., at least 300° F., at least 305° F., at least 310° F., at least 315° F., at least 320° F., at least 325° F., at least 330° F., at least 335° F., at least 340° F., or at least 345° F.). In some embodiments, the unconventional subterranean formation can have a temperature of 350° F. or less (e.g., 345° F. or less, 340° F. or less, 335° F. or less, 330° F. or less, 325° F. or less, 320° F. or less, 315° F. or less, 310° F. or less, 305° F. or less, 300° F. or less, 295° F. or less, 290° F. or less, 285° F. or less, 280° F. or less, 275° F. or less, 270° F. or less, 265° F. or less, 260° F. or less, 255° F. or less, 250° F. or less, 245° F. or less, 240° F. or less, 235° F. or less, 230° F. or less, 225° F. or less, 220° F. or less, 215° F. or less, 210° F. or less, 205° F. or less, 200° F. or less, 195° F. or less, 190° F. or less, 185° F. or less, 180° F. or less, 175° F. or less, 170° F. or less, 165° F. or less, 160° F. or less, 155° F. or less, 150° F. or less, 145° F. or less, 140° F. or less, 135° F. or less, 130° F. or less, 125° F. or less, 120° F. or less, 115° F. or less, 110° F. or less, 105° F. or less, 100° F. or less, 95° F. or less, 90° F. or less, 85° F. or less, or 80° F. or less).

The unconventional subterranean formation can have a temperature ranging from any of the minimum values described above to any of the maximum values described above. For example, in some embodiments, the unconventional subterranean formation can have a temperature of from 75° F. to 350° F. (approximately 24° C. to 176° C.), from 150° F. to 250° F. (approximately 66° C. to 121° C.), from 110° F. to 350° F. (approximately 43° C. to 176° C.), from 110° F. to 150° F. (approximately 43° C. to 66° C.), from 150° F. to 200° F. (approximately 66° C. to 93° C.), from 200° F. to 250° F. (approximately 93° C. to 121° C.), from 250° F. to 300° F. (approximately 121° C. to 149° C.), from 300° F. to 350° F. (approximately 149° C. to 176° C.), from 110° F. to 240° F. (approximately 43° C. to 116° C.), or from 240° F. to 350° F. (approximately 116° C. to 176° C.).

In some embodiments, the salinity of unconventional subterranean formation can be at least 5,000 ppm TDS (e.g., at least 25,000 ppm TDS, at least 50,000 ppm TDS, at least 75,000 ppm TDS, at least 100,000 ppm TDS, at least 125,000 ppm TDS, at least 150,000 ppm TDS, at least 175,000 ppm TDS, at least 200,000 ppm TDS, at least 225,000 ppm TDS, at least 250,000 ppm TDS, or at least 275,000 ppm TDS). In some embodiments, the salinity of unconventional subterranean formation can be 300,000 ppm TDS or less (e.g., 275,000 ppm TDS or less, 250,000 ppm TDS or less, 225,000 ppm TDS or less, 200,000 ppm TDS or less, 175,000 ppm TDS or less, 150,000 ppm TDS or less, 125,000 ppm TDS or less, 100,000 ppm TDS or less, 75,000 ppm TDS or less, 50,000 ppm TDS or less, or 25,000 ppm TDS or less).

The salinity of unconventional subterranean formation can range from any of the minimum values described above to any of the maximum values described above. For example, in some embodiments, the salinity of unconventional subterranean formation can be from 5,000 ppm TDS to 300,000 ppm TDS (e.g., from 100,000 ppm to 300,000 ppm TDS).

In some embodiments, the unconventional subterranean formation can be oil-wet. In some embodiments, the unconventional subterranean formation can be water-wet. In some embodiments, the unconventional subterranean formation can be mixed-wet.

In some embodiments, the aqueous solution can be introduced at a wellhead pressure of at least 0 PSI (e.g., at least 1,000 PSI, at least 2,000 PSI, at least 3,000 PSI, at least 4,000 PSI, at least 5,000 PSI, at least 6,000 PSI, at least 7,000 PSI, at least 8,000 PSI, at least 9,000 PSI, at least 10,000 PSI, at least 15,000 PSI, at least 20,000 PSI, or at least 25,000 PSI). In some embodiments, the aqueous solution can be introduced at a wellhead pressure of 30,000 PSI or less (e.g., 25,000 PSI or less, 20,000 PSI or less, 15,000 PSI or less, 10,000 PSI or less, 9,000 PSI or less, 8,000 PSI or less, 7,000 PSI or less, 6,000 PSI or less, 5,000 PSI or less, 4,000 PSI or less, 3,000 PSI or less, 2,000 PSI or less, or 1,000 PSI or less).

The aqueous solution can be introduced at a wellhead pressure ranging from any of the minimum values described above to any of the maximum values described above. For example, in some embodiments, the aqueous solution can be introduced at a wellhead pressure of from 0 PSI to 30,000 PSI (e.g., from 6,000 PSI to 30,000 PSI, or from 5,000 PSI to 10,000 PSI. In some embodiments, the aqueous solution can be used in a reservoir stimulation operation, and the aqueous solution can be introduced at a wellhead pressure of from 0 PSI to 1,000 PSI.

### Aqueous Solutions

In some embodiments, the aqueous solution can include water. In some embodiments, the aqueous solution can further include a surfactant.

The surfactant can have a concentration within the aqueous solution of at least 0.01% by weight (e.g., at least 0.02% by weight, at least 0.03% by weight, at least 0.04% by weight, at least 0.05% by weight, at least 0.06% by weight, at least 0.07% by weight, at least 0.08% by weight, at least 0.09% by weight, at least 0.1% by weight, at least 0.15% by weight, at least 0.2% by weight, at least 0.25% by weight, at least 0.3% by weight, at least 0.35% by weight, at least 0.4% by weight, at least 0.45% by weight, at least 0.5% by weight, at least 0.55% by weight, at least 0.6% by weight, at least 0.65% by weight, at least 0.7% by weight, at least 0.75% by weight, at least 0.8% by weight, at least 0.85% by weight, at least 0.9% by weight, at least 0.95% by weight, at least 1% by weight, at least 1.25% by weight, at least 1.5% by weight, at least 1.75% by weight, at least 2% by weight, or at least 2.25% by weight), based on the total weight of the aqueous solution. In some embodiments, the surfactant can have a concentration within the aqueous solution of 2.5% by weight or less (e.g., 2.25% by weight or less, 2% by weight or less, 1.75% by weight or less, 1.5% by weight or less, 1.25% by weight or less, 1% by weight or less, 0.95% by weight or less, 0.9% by weight or less, 0.85% by weight or less, 0.8% by weight or less, 0.75% by weight or less, 0.7% by weight or less, 0.65% by weight or less, 0.6% by weight or less, 0.55% by weight or less, 0.5% by weight or less, 0.45% by weight or less, 0.4% by weight or less, 0.35% by weight or less, 0.3% by weight or less, 0.25% by weight or less, 0.2% by weight or less, 0.15% by weight or less, 0.1% by weight or less, 0.09% by weight or less, 0.08% by weight or less, 0.07% by weight or less, 0.06% by weight or less, 0.05% by weight or less, 0.04% by weight or less, 0.03% by weight or less, or 0.02% by weight or less), based on the total weight of the aqueous solution. In particular embodiments, the surfactant can have a concentration within the aqueous solution of less than 1%, less than 0.5%, less than 0.2%, less than 0.1%, less than 0.075%, or less than 0.05%.

The surfactant can have a concentration within the aqueous solution ranging from any of the minimum values described above to any of the maximum values described above. For example, in some embodiments, the surfactant can have a concentration within the aqueous solution of from 0.01% to 2.5% by weight (e.g., from 0.05% to 0.5% by weight, from 0.01% to 2% by weight, from 0.01% to 1.5% by weight, from 0.01% to 1% by weight, from 0.01% to 0.5% by weight, from 0.01% to 0.1% by weight, from 0.01% to 0.05% by weight, from 0.1% to 2.5% by weight, from 0.1% to 2% by weight, from 0.1% to 1.5% by weight, from 0.1% to 1% by weight, from 0.1% to 0.5% by weight, from 0.1% to 0.05% by weight, from 0.5% to 2.5% by weight, from 0.5% to 2% by weight, from 0.5% to 1.5% by weight, from 0.5% to 1% by weight, from 1% to 2.5% by weight, from 1% to 2% by weight, from 1% to 1.5% by weight, from 1.5% to 2.5% by weight, from 1.5% to 2% by weight, or from 2% to 2.5% by weight), based on the total weight of the aqueous solution.

In some embodiments, the aqueous solution can further include an acid, an alkali agent, co-solvent, a co-surfactant, a foam stabilizer, a viscosity modifying polymer, a chelating agent (e.g., EDTA or a salt thereof), a clay swelling inhibitor (e.g., KCl), a biocide, a scale inhibitor, a breaker, a corrosion inhibitor, a sulfide scavenger, or any combination thereof. In some embodiments, the aqueous solution can further include an acid, an alkali agent, co-solvent, a co-surfactant, a foam stabilizer, a viscosity modifying polymer, a breaker, or any combination thereof.

### Surfactants

Examples of suitable surfactants can include, but is not limited to a non-ionic surfactant, an anionic surfactant, or any combination thereof. In some embodiments, the hydrophilic-lipophilic balance (HLB) of the non-ionic surfactant is greater than 10 (e.g., greater than 9, greater than 8, or greater than 7). In some embodiments, the HLB of the non-ionic surfactant is from 7 to 10.

The non-ionic surfactant can comprise a hydrophobic tail comprising from 6 to 60 carbon atoms. In some embodiments, the non-ionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the non-ionic surfactant can include a hydrophobic tail that comprises 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The non-ionic surfactant can include a hydrophobic tail that comprises a number of carbon atoms ranging from any of the minimum values described above to any of the maximum values described above. For example, the non-ionic surfactant can comprise a hydrophobic tail comprising from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. In some cases, the hydrophobic tail may be a straight chain, branched chain, and/or may comprise cyclic structures. The hydrophobic carbon tail may comprise single bonds, double bonds, triple bonds, or any combination thereof. In some cases, the hydrophobic tail can comprise an alkyl group, with or without an aromatic ring (e.g., a phenyl ring) attached to it. In some embodiments, the hydrophobic tail can comprise a branched hydrophobic tail derived from Guerbet alcohols.

Example non-ionic surfactants include alkyl aryl alkoxy alcohols, alkyl alkoxy alcohols, or any combination thereof. In embodiments, the non-ionic surfactant may be a mix of surfactants with different length lipophilic tail chain lengths. For example, the non-ionic surfactant may be C9-C11:9EO, which indicates a mixture of non-ionic surfactants that have a lipophilic tail length of 9 carbon to 11 carbon, which is followed by a chain of 9 EOs. The hydrophilic moiety is an alkylencoxy chain (e.g., an ethoxy (EO), butoxy (BO) and/or propoxy (PO) chain with two or more repeating units of EO, BO, and/or PO). In some embodiments, 1-100 repeating units of EO are present. In some embodiments, 0-65 repeating units of PO are present. In some embodiments, 0-25 repeating units of BO are present. For example, the non-ionic surfactant could comprise 10EO: 5PO or 5EO. In embodiments, the non-ionic surfactant may be a mix of surfactants with different length lipophilic tail chain lengths. For example, the non-ionic surfactant may be C9-C11:PO9:EO2, which indicates a mixture of non-ionic surfactants that have a lipophilic tail length of 9 carbon to 11 carbon, which is followed by a chain of 9 POs and 2 EOs. In specific embodiments, the non-ionic surfactant is linear C9-C11:9EO. In some embodiments, the non-ionic surfactant is a Guerbet PO(0-65) and EO(0-100) (Guerbet can be C6-C36); or alkyl PO(0-65) and EO(0-100): where the alkyl group is linear or branched C₁-C36. In some examples, the non-ionic surfactant can comprise a branched or unbranched C6-C32:PO(0-65):EO(0-100) (e.g., a branched or unbranched C6-C30:PO(30-40):EO(25-35), a branched or unbranched C6-C12:PO(30-40):EO(25-35), a branched or unbranched C6-30:EO(8-30), a branched or unbranched C11-15:EO(30-50), a branched or unbranched C11-15:EO(35-45), a branched or unbranched C16:22:EO(20-30), a branched or unbranched C16:22:EO(30-50), a branched or unbranched C16:22:EO(35-45), a branched or unbranched C22-30:EO(30-40):EO(25-35), or any combination thereof). In some embodiments, the non-ionic surfactant is one or more alkyl polyglucosides.

Suitable anionic surfactants can include a hydrophobic tail that comprises from 6 to 60 carbon atoms. In some embodiments, the anionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the anionic surfactant can include a hydrophobic tail that comprises 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The anionic surfactant can include a hydrophobic tail that comprises a number of carbon atoms ranging from any of the minimum values described above to any of the maximum values described above. For example, in some embodiments, the anionic surfactant can comprise a hydrophobic tail comprising from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. The hydrophobic (lipophilic) carbon tail may be a straight chain, branched chain, and/or may comprise cyclic structures. The hydrophobic carbon tail may comprise single bonds, double bonds, triple bonds, or any combination thereof. In some embodiments, the anionic surfactant can include a branched hydrophobic tail derived from Guerbet alcohols. The hydrophilic portion of the anionic surfactant can comprise, for example, one or more sulfate moieties (e.g., one, two, or three sulfate moieties), one or more sulfonate moieties (e.g., one, two, or three sulfonate moieties), one or more sulfosuccinate moieties (e.g., one, two, or three sulfosuccinate moieties), one or more carboxylate moieties (e.g., one, two, or three carboxylate moieties), or any combination thereof.

In some embodiments, the anionic surfactant can comprise, for example a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof. In some examples, the anionic surfactant can comprise an internal olefin sulfonate (IOS), an isomerized olefin sulfonate, an alfa olefin sulfonate (AOS), an alkyl aryl sulfonate (AAS), a xylene sulfonate, an alkane sulfonate, a petroleum sulfonate, an alkyl diphenyl oxide (di) sulfonate, an alcohol sulfate, an alkoxy sulfate, an alkoxy sulfonate, an alkoxy carboxylate, an alcohol phosphate, or an alkoxy phosphate. In some embodiments, the anionic surfactant can comprise an alkoxy carboxylate surfactant, an alkoxy sulfate surfactant, an alkoxy sulfonate surfactant, an alkyl sulfonate surfactant, an aryl sulfonate surfactant, or an olefin sulfonate surfactant.

An “alkoxy carboxylate surfactant” or “alkoxy carboxylate” refers to a compound having an alkyl or aryl attached to one or more alkoxylene groups (typically —CH₂—CH (ethyl)-O—, —CH₂—CH(methyl)-O—, or —CH₂—CH₂—O—) which, in turn is attached to —COO⁻ or acid or salt thereof including metal cations such as sodium. In embodiments, the alkoxy carboxylate surfactant can be defined by the formulae below:

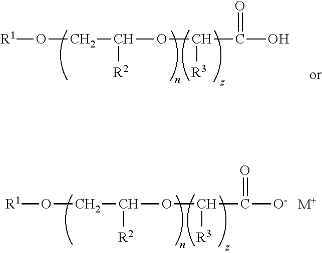

wherein R¹ is substituted or unsubstituted C6-C36 alkyl or substituted or unsubstituted aryl; R² is, independently for each occurrence within the compound, hydrogen or unsubstituted C1-C6 alkyl; R³ is independently hydrogen or unsubstituted C1-C6 alkyl, n is an integer from 0 to 175, z is an integer from 1 to 6 and M⁺ is a monovalent, divalent or trivalent cation. In some of these embodiments, R¹ can be an unsubstituted linear or branched C6-C36 alkyl.

In certain embodiments, the alkoxy carboxylate can be a C6-C32:PO(0-65):EO(0-100)-carboxylate (i.e., a C6-C32 hydrophobic tail, such as a branched or unbranched C6-C₃₂ alkyl group, attached to from 0 to 65 propyleneoxy groups (—CH₂—CH(methyl)-O-linkers), attached in turn to from 0 to 100 ethyleneoxy groups (—CH₂—CH₂—O-linkers), attached in turn to —COO— or an acid or salt thereof including metal cations such as sodium). In certain embodiments, the alkoxy carboxylate can be a branched or unbranched C6-C30:PO(30-40):EO(25-35)-carboxylate. In certain embodiments, the alkoxy carboxylate can be a branched or unbranched C6-C12:PO(30-40):EO(25-35)-carboxylate. In certain embodiments, the alkoxy carboxylate can be a branched or unbranched C6-C30:EO(8-30)-carboxylate.

An “alkoxy sulfate surfactant” or “alkoxy sulfate” refers to a surfactant having an alkyl or aryl attached to one or more alkoxylene groups (typically —CH₂—CH (ethyl)-O—, —CH₂—CH(methyl)-O—, or —CH₂—CH₂—O—) which, in turn is attached to —SO₃— or acid or salt thereof including metal cations such as sodium. In some embodiment, the alkoxy sulfate surfactant has the formula R—(BO)e-(PO)f-(EO)g-SO3- or acid or salt (including metal cations such as sodium) thereof, wherein R is C6-C32 alkyl, BO is —CH₂—CH (ethyl)-O—, PO is —CH₂—CH(methyl)-O—, and EO is —CH₂—CH₂—O—. The symbols e, f and g are integers from 0 to 50 wherein at least one is not zero.

In embodiments, the alkoxy sulfate surfactant can be an aryl alkoxy sulfate surfactant. The aryl alkoxy surfactant can be an alkoxy surfactant having an aryl attached to one or more alkoxylene groups (typically —CH₂—CH (ethyl)-O—, —CH₂—CH(methyl)-O—, or —CH₂—CH₂—O—) which, in turn is attached to —SO₃— or acid or salt thereof including metal cations such as sodium.

An “alkyl sulfonate surfactant” or “alkyl sulfonate” refers to a compound that includes an alkyl group (e.g., a branched or unbranched C6-C32 alkyl group) attached to —SO3- or acid or salt thereof including metal cations such as sodium.

An “aryl sulfate surfactant” or “aryl sulfate” refers to a compound having an aryl group attached to —O—SO3- or acid or salt thereof including metal cations such as sodium. An “aryl sulfonate surfactant” or “aryl sulfonate” refers to a compound having an aryl group attached to —SO3- or acid or salt thereof including metal cations such as sodium. In some cases, the aryl group can be substituted, for example, with an alkyl group (an alkyl aryl sulfonate).

An “internal olefin sulfonate,” “isomerized olefin sulfonate,” or “IOS” refers to an unsaturated hydrocarbon compound comprising at least one carbon-carbon double bond and at least one SO3- group, or a salt thereof. As used herein, a “C20-C28 internal olefin sulfonate,” “a C20-C28 isomerized olefin sulfonate,” or “C20-C28 IOS” refers to an IOS, or a mixture of IOSs with an average carbon number of 20 to 28, or of 23 to 25. The C20-C28 IOS may comprise at least 80% of IOS with carbon numbers of 20 to 28, at least 90% of IOS with carbon numbers of 20 to 28, or at least 99% of IOS with carbon numbers of 20 to 28. As used herein, a “C15-C18 internal olefin sulfonate,” “C15-C18 isomerized olefin sulfonate,” or “C15-C18 IOS” refers to an IOS or a mixture of IOSs with an average carbon number of 15 to 18, or of 16 to 17. The C15-C18 IOS may comprise at least 80% of IOS with carbon numbers of 15 to 18, at least 90% of IOS with carbon numbers of 15 to 18, or at least 99% of IOS with carbon numbers of 15 to 18. The internal olefin sulfonates or isomerized olefin sulfonates may be alpha olefin sulfonates, such as an isomerized alpha olefin sulfonate. The internal olefin sulfonates or isomerized olefin sulfonates may also comprise branching. In certain embodiments, C15-18 IOS may be added to the single-phase liquid surfactant package when the LPS injection fluid is intended for use in high temperature unconventional subterranean formations, such as formations above 130° F. (approximately 55° C.). The IOS may be at least 20% branching, 30% branching, 40% branching, 50% branching, 60% branching, or 65% branching. In some embodiments, the branching is between 20-98%, 30-90%, 40-80%, or around 65%. Examples of internal olefin sulfonates and the methods to make them are found in U.S. Pat. No. 5,488,148, U.S. Patent Application Publication 2009/0112014, and SPE 129766, all incorporated herein by reference.

In embodiments, the anionic surfactant can be a disulfonate, alkyldiphenyloxide disulfonate, mono alkyldiphenyloxide disulfonate, di alkyldiphenyloxide disulfonate, or a di alkyldiphenyloxide monosulfonate, where the alkyl group can be a C6-C36 linear or branched alkyl group. In embodiments, the anionic surfactant can be an alkylbenzene sulfonate or a dibenzene disufonate. In embodiments, the anionic surfactant can be benzenesulfonic acid, decyl(sulfophenoxy)-disodium salt; linear or branched C6-C36 alkyl:PO(0-65):EO(0-100) sulfate; or linear or branched C6-C36 alkyl:PO(0-65):EO(0-100) carboxylate. In embodiments, the anionic surfactant is an isomerized olefin sulfonate (C6-C30), internal olefin sulfonate (C6-C30) or internal olefin disulfonate (C6-C30). In some embodiments, the anionic surfactant is a Guerbet-PO(0-65)-EO(0-100) sulfate (Guerbet portion can be C6-C36). In some embodiments, the anionic surfactant is a Guerbet-PO(0-65)-EO(0-100) carboxylate (Guerbet portion can be C6-C36). In some embodiments, the anionic surfactant is alkyl PO(0-65) and EO(0-100) sulfonate: where the alkyl group is linear or branched C6-C36. In some embodiments, the anionic surfactant is a sulfosuccinate, such as a dialkylsulfosuccinate. In some embodiments, the anionic surfactant is an alkyl aryl sulfonate (AAS) (e.g. an alkyl benzene sulfonate (ABS)), a C10-C30 internal olefin sulfate (IOS), a petroleum sulfonate, or an alkyl diphenyl oxide (di) sulfonate.

In some examples, the anionic surfactant can comprise a surfactant defined by the formula below:

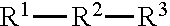

wherein R¹ comprises a branched or unbranched, saturated or unsaturated, cyclic or non-cyclic, hydrophobic carbon chain having 6-32 carbon atoms and an oxygen atom linking R¹ and R²; R² comprises an alkoxylated chain comprising at least one oxide group selected from the group consisting of ethylene oxide, propylene oxide, butylene oxide, and combinations thereof; and R³ comprises a branched or unbranched hydrocarbon chain comprising 2-12 carbon atoms and from 2 to 5 carboxylate groups.

In some examples, the anionic surfactant can comprise a surfactant defined by the formula below:

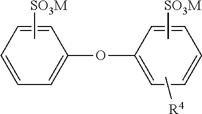

wherein R⁴ is a branched or unbranched, saturated or unsaturated, cyclic or non-cyclic, hydrophobic carbon chain having 6-32 carbon atoms; and M represents a counterion (e.g., Na+, K+). In some embodiments, R⁴ is a branched or unbranched, saturated or unsaturated, cyclic or non-cyclic, hydrophobic carbon chain having 6-16 carbon atoms.

In some embodiments, the nonionic surfactant can have a concentration within the aqueous solution of at least 0.1% by weight (e.g., at least 0.15% by weight, or at least 0.2% by weight).

In some embodiments, the nonionic surfactant can have a concentration within the aqueous solution of 0.25% by weight or less (e.g., 0.2% by weight or less, 0.15% by weight or less).

The nonionic surfactant can have a concentration within the aqueous solution ranging from any of the minimum values described above to any of the maximum values described above. For example, in some embodiments, the nonionic surfactant can have a concentration within the aqueous solution of from 0.1% to 0.25% by weight (e.g., from 0.1% to 0.125%, from 0.1% to 0.2%, from 0.125% to 0.25%, from 0.125% to 0.2%, or from 0.2% to 0.25%). In some embodiments, the anionic surfactant can have a concentration within the aqueous solution of from 0.1% to 0.25% by weight (e.g., from 0.1% to 0.125%, from 0.1% to 0.2%, from 0.125% to 0.25%, from 0.125% to 0.2%, or from 0.2% to 0.25%).

In some embodiments, the surfactants can be present in the aqueous solution in a weight ratio of non-ionic surfactant to anionic surfactant of at least 0.5 (e.g., at least 1, at least 1.5, at least 2, at least 2.5, at least 3, at least 3.5, at least 4, or at least 4.5).

In some embodiments, the surfactants can be present in the aqueous solution in a weight ratio of non-ionic surfactant to anionic surfactant of 5 or less (e.g., 4.5 or less, 4 or less, 3.5 or less, 3 or less, 2.5 or less, 2 or less, 1.5 or less, or 1 or less).

The surfactants can be present in the aqueous solution in a weight ratio of non-ionic surfactant to anionic surfactant ranging from any of the minimum values described above to any of the maximum values described above. For example, in some embodiments, the surfactants can be present in the aqueous solution in a weight ratio of non-ionic surfactant to anionic surfactant of from 0.5 to 5 (e.g., from 0.5 to 4, from 0.5 to 3, from 0.5 to 2, from 0.5 to 1, from 1 to 5, from 1 to 4, from 1 to 3, from 1 to 2, from 2 to 5, from 2 to 4, from 2 to 3, from 3 to 4, from 3 to 5, or from 4 to 5).

In some embodiments, the aqueous solution can include a non-ionic surfactant and an anionic surfactant (e.g., a sulfonate or disulfonate). In some embodiments, the aqueous solution can include a non-ionic surfactant and two or more anionic surfactants (e.g., a sulfonate or disulfonate and a carboxylate). In some embodiments, the aqueous solution can include a non-ionic surfactant (e.g., a C6-C16 alkyl phenol ethoxylate, or a C6-C16:PO(0-25):EO(0-25), such as a C9-C11 ethoxylated alcohol, a C13 ethoxylated alcohol, a C6-C10 ethoxylated propoxylated alcohol, or a C10-C14 ethoxylated Guerbet alcohol) and a sulfonate surfactant (e.g., a C10-16 disulfonate, or a C16-28 IOS). In some embodiments, the aqueous solution can include a non-ionic surfactant (e.g., a C6-C16 alkyl phenol ethoxylate, or a C6-16:PO(0-25):EO(0-25), such as a C9-C11 ethoxylated alcohol, a C13 ethoxylated alcohol, a C6-C₁₀ ethoxylated propoxylated alcohol, or a C10-C14 ethoxylated Guerbet alcohol), a sulfonate surfactant (e.g., a C10-16 disulfonate, or a C16-28 IOS), and a carboxylate surfactant (e.g., a C10-16 alkyl polyglucoside carboxylate or a C22-C36 Guerbet alkoxylated carboxylate).

Specific example embodiments include formulations including surfactants and co-surfactants in the table below.

| Compo- | Surfactants and Co-Surfactants in composition |
|---|---|
| sition | (in weight percent) |
| 1 | 0.09% alkoxylated C6-C16 alcohol |
| | 0.06% disulfonate |
| 2 | 0.1% alkoxylated C6-C16 alcohol |
| | 0.1% carboxylate |
| | 0.1% disulfonate |
| 3 | 0.15% alkoxylated C6-C16 alcohol |
| | 0.075% carboxylate |
| | 0.075% disulfonate |
| 4 | 0.2% alkoxylated C6-C16 alcohol |
| | 0.1% carboxylate |
| 5 | 0.2% alkoxylated C6-C16 alcohol |
| | 0.033% carboxylate |
| | 0.066% disulfonate |
| 6 | 0.2% alkoxylated C6-C16 alcohol |
| | 0.033% carboxylate |
| | 0.066% disulfonate |
| 7 | 0.2% alkoxylated C6-C16 alcohol |
| | 0.05% carboxylate |
| | 0.05% olefin sulfonate |
| 8 | 0.15% alkoxylated C6-C16 alcohol |
| | 0.05% carboxylate |
| | 0.05% olefin sulfonate |
| | 0.05% alkyl polyglucoside |
| 9 | 0.1% alkoxylated C6-C16 alcohol |
| | 0.05% carboxylate |
| | 0.05% olefin sulfonate |
| | 0.1% alkyl polyglucoside |
| 10 | 0.15% alkoxylated C6-C16 alcohol |
| | 0.07% carboxylate |
| | 0.03% olefin sulfonate |
| | 0.1% alkyl polyglucoside |
| 11 | 0.1% alkoxylated C6-C16 alcohol |
| | 0.04% carboxylate |
| | 0.05% olefin sulfonate |
| | 0.03% disulfonate |
| | 0.1% alkyl polyglucoside |
| 12 | 0.1% alkoxylated C6-C16 alcohol |
| | 0.04% carboxylate |
| | 0.06% disulfonate |
| | 0.1% alkyl polyglucoside |
| 13 | 0.15% alkoxylated C6-C16 alcohol |
| | 0.15% alkoxylated alkylphenol |
| | 0.1% olefin sulfonate |
| | 0.1% Guerbet alkoxylated carboxylate |
| 14 | 0.125% alkoxylated C6-C16 alcohol |
| | 0.175% alkoxylated alkylphenol |
| | 0.1% olefin sulfonate |
| | 0.1% Guerbet alkoxylated carboxylate |
| 15 | 0.1% alkoxylated C6-C16 alcohol |
| | 0.2% alkoxylated alkylphenol |
| | 0.1% olefin sulfonate |
| | 0.1% Guerbet alkoxylated carboxylate |
| 16 | 0.12% alkoxylated C6-C16 alcohol |
| | 0.22% alkoxylated alkylphenol |
| | 0.08% olefin sulfonate |
| | 0.08% Guerbet alkoxylated carboxylate |
| 17 | 0.15% alkoxylated C6-C16 alcohol |
| | 0.15% alkoxylated alkylphenol |
| | 0.08% olefin sulfonate |
| | 0.06% Guerbet alkoxylated carboxylate |
| | 0.06% carboxylate |
| 18 | 0.15% alkoxylated C6-C16 alcohol |
| | 0.15% alkoxylated alkylphenol |
| | 0.05% olefin sulfonate |
| | 0.1% Guerbet alkoxylated carboxylate |
| | 0.05% disulfonate |
| 19 | 0.5% olefin sulfonate |
| | 0.5% Guerbet alkoxylated carboxylate |
| | 0.55% glycosides or glucosides |
| 20 | 0.5% olefin sulfonate |
| | 0.5% Guerbet alkoxylated carboxylate |
| | 0.5% glycosides or glucosides |
| | 0.25% alkoxylated C6-C16 alcohol |
| 21 | 0.5% olefin sulfonate |
| | 0.5% Guerbet alkoxylated carboxylate |
| | 0.5% glycosides or glucosides |
| | 0.5% alkoxylated C6-C16 alcohol |
| 22 | 0.5% olefin sulfonate |
| | 0.5% Guerbet alkoxylated carboxylate |
| | 1% glycosides or glucosides |
| | 0.5% alkoxylated C6-C16 alcohol |
| 23 | 0.05% olefin sulfonate |
| | 0.05% Guerbet alkoxylated carboxylate |
| | 0.05% glycosides or glucosides |
| | 0.05% alkoxylated C6-C16 alcohol |
| 24 | 0.075% glycosides or glucosides |
| | 0.075% alkoxylated C6-C16 alcohol |
| 25 | 0.1% alkoxylated C6-C16 alcohol |
| | 0.05% disulfonate |
| 26 | 0.1% alkoxylated C6-C16 alcohol |
| | 0.05% disulfonate |
| | 0.03% hydroxyalkyl alkylammonium chloride |
| 27 | 0.03% olefin sulfonate |
| | 0.04% Guerbet alkoxylated carboxylate |
| | 0.08% glycosides or glucosides |
| | 0.05% alkoxylated C6-C16 alcohol |
| 28 | 0.4% olefin sulfonate |
| | 0.4% Guerbet alkoxylated carboxylate |
| | 0.7% glycosides or glucosides |
| | 0.5% alkoxylated C6-C16 alcohol |
| 29 | 0.05% olefin sulfonate |
| | 0.1% glycosides or glucosides |
| | 0.05% alkoxylated C6-C16 alcohol |
| 30 | 0.05% olefin sulfonate |
| | 0.1% alkyl polyglucoside |
| | 0.05% alkoxylated C6-C16 alcohol |
| 31 | 0.05% olefin sulfonate |
| | 0.1% glycosides or glucosides |
| | 0.05% alkoxylated C6-C16 alcohol |
| 32 | 0.05% olefin sulfonate |
| | 0.1% alkyl polyglucoside |
| | 0.05% alkoxylated C6-C16 alcohol |
| 33 | 0.05% olefin sulfonate |
| | 0.1% alkyl polyglucoside |
| | 0.05% alkoxylated C6-C16 alcohol |
| 34 | 0.05% olefin sulfonate |
| | 0.05% glycosides or glucosides |
| | 0.05% alkoxylated C6-C16 alcohol |
| | 0.05% carboxylate |
| 35 | 0.05% olefin sulfonate |
| | 0.05% glycosides or glucosides |
| | 0.05% alkoxylated C6-C16 alcohol |
| | 0.05% carboxylate |
| 36 | 0.05% olefin sulfonate |
| | 0.05% alkyl polyglucoside |
| | 0.05% alkoxylated C6-C16 alcohol |
| 37 | 0.06% olefin sulfonate |
| | 0.05% alkyl polyglucoside |
| | 0.04% alkoxylated C6-C16 alcohol |
| 38 | 0.04% olefin sulfonate |
| | 0.08% glycosides or glucosides |
| | 0.05% alkoxylated C6-C16 alcohol |
| | 0.03% disulfonate |
| 39 | 0.035% olefin sulfonate |
| | 0.075% glycosides or glucosides |
| | 0.05% alkoxylated C6-C16 alcohol |
| | 0.04% disulfonate |
| 40 | 0.035% olefin sulfonate |
| | 0.07% glycosides or glucosides |
| | 0.045% alkoxylated C6-C16 alcohol |
| | 0.05% disulfonate |
| 41 | 0.1% alkoxylated C6-C16 alcohol |
| | 0.1% disulfonate |
| 42 | 0.25% Guerbet alkoxylated carboxylate |
| | 0.25% olefin sulfonate |
| | 0.5% glycosides or glucosides |
| | 0.5% co-solvent |
| 43 | 0.075% alkoxylated C12-C22 alcohol |
| | 0.075% disulfonate |
| 44 | 0.075% alkoxylated C6-C16 Guerbet alcohol |
| | 0.075% disulfonate |
| 45 | 0.075% alkoxylated C6-C16 Guerbet alcohol |
| | 0.075% disulfonate |
| 46 | 0.075% alkoxylated C6-C16 alcohol |
| | 0.075% disulfonate |
| 47 | 0.075% disulfonate |
| | 0.075% alkoxylated C6-C16 alcohol |
| 48 | 0.0625% disulfonate |
| | 0.0875% alkoxylated C6-C16 alcohol |
| 49 | 0.055% disulfonate |
| | 0.095% alkoxylated C6-C16 alcohol |
| 50 | 0.075% disulfonate |
| | 0.075% alkoxylated C6-C16 alcohol |
| 51 | 1% alkoxylated C6-C16 alcohol |
| | 0.5% disulfonate |
| 52 | 1% alkoxylated C6-C16 alcohol |
| 53 | 1% alkoxylated C6-C16 alcohol |
| | 2.25% sulfosuccinate |
| 54 | 0.25% Guerbet alkoxylated carboxylate |
| | 1% alkoxylated C6-C16 alcohol |
| | 2.25% sulfosuccinate |
| 55 | 0.25% Guerbet alkoxylated carboxylate |
| | 1% alkoxylated alkylphenol |
| | 2.25% sulfosuccinate |
| 56 | 0.25% Guerbet alkoxylated carboxylate |
| | 1% alkoxylated C6-C16 alcohol |
| 57 | 0.25 Guerbet alkoxylated carboxylate |
| | 1% alkoxylated alkylphenol |
| 58 | 0.65% carboxylate |
| | 0.35% alkoxylated C6-C16 alcohol |
| 59 | 0.325% carboxylate |
| | 0.925% alkoxylated C6-C16 alcohol |
| 60 | 0.25% olefin sulfonate |
| | 1.0% alkoxylated C6-C16 alcohol |
| 61 | 0.15% olefin sulfonate |
| | 0.2% Guerbet alkoxylated carboxylate |
| | 0.92% carboxylate |
| 62 | 0.65% carboxylate |
| | 0.35% second carboxylate |
| 63 | 0.65% carboxylate |
| | 0.35% alkoxylated C6-C16 alcohol |
| | 1% olefin sulfonate |
| 64 | 1% alkoxylated alcohol |
| | 1% olefin sulfonate |
| 65 | 0.5% alkoxylated alcohol |
| | 0.5% olefin sulfonate |
| | 0.25% carboxylate |
| 66 | 0.6% co-solvent |
| | 0.6% olefin sulfonate |
| 67 | 0.6% co-solvent |
| | 0.3% disulfonate |
| | 0.3% olefin sulfonate |
| 68 | 0.6% Guerbet alkoxylated carboxylate |
| | 0.6% disulfonate |
| 69 | 0.6% co-solvent |
| | 0.4% disulfonate |
| | 0.2% olefin sulfonate |
| 70 | 0.5% alkoxylated C6-C16 alcohol |
| | 0.4% disulfonate |
| | 0.3% olefin sulfonate |
| 71 | 1% alkoxylated C6-C16 alcohol |
| 72 | 0.9% alkoxylated C6-C16 alcohol |
| | 0.6% disulfonate |
| 73 | 0.4% alkoxylated C6-C16 alcohol |
| | 0.35% disulfonate |
| | 0.25% olefin sulfonate |
| | 0.5% co-solvent |
| 74 | 0.25% Guerbet alkoxylated carboxylate |
| | 0.5% alkoxylated C6-C16 alcohol |
| | 0.35% disulfonate |
| | 0.15% olefin sulfonate |
| | 0.35% co-solvent |
| 75 | 0.25% Guerbet alkoxylated carboxylate |
| | 0.25% alkoxylated C6-C16 alcohol |
| | 0.25% olefin sulfonate |
| | 0.25% co-solvent |
| 76 | 0.25% Guerbet alkoxylated carboxylate |
| | 0.25% alkoxylated C6-C16 alcohol |
| | 0.25% olefin sulfonate |
| | 0.25% alkoxylated alcohol |
| 77 | 0.25% Guerbet alkoxylated carboxylate |
| | 0.35% olefin sulfonate |
| | 0.5% alkoxylated alcohol |
| 78 | 0.25% Guerbet alkoxylated carboxylate |
| | 0.25% alkoxylated C6-C16 alcohol |
| | 0.15% olefin sulfonate |
| | 0.1% disulfonate |
| | 0.25% co-solvent |
| 79 | 0.25% Guerbet alkoxylated carboxylate |
| | 0.25% alkoxylated C6-C16 alcohol |
| | 0.25% olefin sulfonate |
| | 0.25% glycosides or glucosides |
| | 0.25% co-solvent |
| | 0.15% disulfonate |
| 80 | 0.25% Guerbet alkoxylated carboxylate |
| | 0.25% olefin sulfonate |
| | 0.5% glycosides or glucosides |
| | 0.25% co-solvent |
| 81 | 0.15% alkoxylated C12-C22 alcohol |
| 82 | 0.075% alkoxylated C12-C22 alcohol |
| | 0.075% disulfonate |
| 83 | 0.075% alkoxylated C12-C22 alcohol |
| | 0.075% disulfonate |
| 84 | 0.075% alkoxylated C12-C22 alcohol |
| | 0.075% alkoxylated C6-C16 Guerbet alcohol |
| 85 | 0.15% alkoxylated C6-C16 Guerbet alcohol |
| 86 | 0.075% alkoxylated C6-C16 Guerbet alcohol |
| | 0.075% disulfonate |
| 87 | 0.075% alkoxylated C6-C16 Guerbet alcohol |
| | 0.075% disulfonate |
| | 0.05% co-solvent |
| 88 | 0.1% alkoxylated C6-C16 alcohol |
| | 0.05% disulfonate |
| 89 | 1% alkoxylated C6-C16 alcohol |
| | 0.5% disulfonate |
| 90 | 0.075% alkoxylated C6-C16 Guerbet alcohol |
| | 0.075% disulfonate |
| 91 | 0.075% alkoxylated C6-C16 Guerbet alcohol |
| | 0.125% disulfonate |
| 92 | 0.075% alkoxylated C12-C22 alcohol |
| | 0.125% disulfonate |
| 93 | 0.075% alkoxylated C12-C22 alcohol |
| | 0.075% disulfonate |
| 94 | 0.075% alkoxylated C6-C16 Guerbet alcohol |
| | 0.075% disulfonate |
| 95 | 0.1% alkoxylated C6-C16 Guerbet alcohol |
| | 0.05% disulfonate |
| 96 | 0.075% alkoxylated C6-C16 Guerbet alcohol |
| | 0.075% disulfonate |
| 97 | 0.075% alkoxylated C6-C16 alcohol |
| | 0.075% disulfonate |
| 98 | 0.075% alkoxylated C6-C16 Guerbet alcohol |
| | 0.075% disulfonate |
| 99 | 0.1% alkoxylated C6-C16 alcohol |
| | 0.05% disulfonate |
| 100 | 0.09% alkoxylated C6-C16 alcohol |
| | 0.06% disulfonate |
| 101 | 0.1% alkoxylated C6-C16 alcohol |
| | 0.1% disulfonate |
| | 0.1% Guerbet alkoxylated carboxylate |
| 102 | 0.1% alkoxylated C6-C16 alcohol |
| | 0.1% disulfonate |
| 103 | 0.65% Guerbet alkoxylated carboxylate |
| | 0.35% olefin sulfonate |
| | 0.33% alkoxylated alkylphenol |
| | 0.5% co-solvent |
| | 0.25% second co-solvent |
| 104 | 0.075% alkoxylated C6-C16 alcohol |
| | 0.075% benzenesulfonic acid, decyl(sulfophenoxy)-disodium |
| | salt |
| 105 | 0.15% alkoxylated C6-C16 alcohol |
| | 0.05% benzenesulfonic acid, decyl(sulfophenoxy)-disodium |
| | salt |

In some cases, the subterranean formation can include fractures. These fractures can be naturally occurring fractures present within a formation. For example, in some embodiments, the formation can include naturally fractured carbonate or naturally fractured sandstone. The presence or absence of naturally occurring fractures within a subterranean formation can be assessed using standard methods known in the art, including seismic surveys, geology, outcrops, cores, logging, reservoir characterization including preparing grids, etc. In other embodiments, the formation can comprise fractures generated by a fracturing operation. In other embodiments, the formation can comprise fractures generated by a fracturing operation.

### Co-Surfactants

In some embodiments, the aqueous solution can include a co-surfactant. Examples of suitable co-surfactants can include, but are not limited to, one or more anionic surfactants, one or more cationic surfactants, one or more non-ionic surfactants, one or more zwitterionic surfactants, one or more amphoterics, one or more fluorinated surfactants, or any combination thereof.

Example cationic surfactants include surfactant analogous to those described above, except bearing primary, secondary, or tertiary amines, or quaternary ammonium cations, as a hydrophilic head group. “Zwitterionic” or “zwitterion” as used herein refers to a neutral molecule with a positive (or cationic) and a negative (or anionic) electrical charge at different locations within the same molecule. Example zwitterionic surfactants include betains and sultains.

Examples of suitable surfactants are disclosed, for example, in U.S. Pat. Nos. 3,811,504, 3,811,505, 3,811,507, 3,890,239, 4,463,806, 6,022,843, 6,225,267, 7,629,299, 7,770,641, 9,976,072, 8,211, 837, 9,422,469, 9,605,198, and 9,617,464; WIPO Patent Application Nos. WO/2008/079855, WO/2012/027757 and WO/2011/094442; as well as U.S.

Patent Application Nos. 2005/0199395, 2006/0185845, 2006/0189486, 2009/0270281, 2011/0046024, 2011/0100402, 2011/0190175, 2007/0191633, 2010/004843, 2011/0201531, 2011/0190174, 2011/0071057, 2011/0059873, 2011/0059872, 2011/0048721, 2010/0319920, 2010/0292110, and 2017/0198202, each of which is hereby incorporated by reference herein in its entirety for its description of example surfactants.

When present, the one or more co-surfactants can have a concentration within the aqueous solution of at least 0.001% by weight (e.g., at least 0.005% by weight, at least 0.01% by weight, at least 0.02% by weight, at least 0.03% by weight, at least 0.04% by weight, at least 0.05% by weight, at least 0.06% by weight, at least 0.07% by weight, at least 0.08% by weight, at least 0.09% by weight, at least 0.1% by weight, at least 0.15% by weight, at least 0.2% by weight, at least 0.25% by weight, at least 0.3% by weight, at least 0.35% by weight, at least 0.4% by weight, at least 0.45% by weight, at least 0.5% by weight, at least 0.55% by weight, at least 0.6% by weight, at least 0.65% by weight, at least 0.7% by weight, at least 0.75% by weight, at least 0.8% by weight, at least 0.85% by weight, at least 0.9% by weight, at least 0.95% by weight, at least 1% by weight, at least 1.25% by weight, at least 1.5% by weight, at least 1.75% by weight, at least 2% by weight, or at least 2.25% by weight), based on the total weight of the aqueous solution. In some embodiments, the one or more co-surfactants can have a concentration within the aqueous solution of 2.5% by weight or less (e.g., 2.25% by weight or less, 2% by weight or less, 1.75% by weight or less, 1.5% by weight or less, 1.25% by weight or less, 1% by weight or less, 0.95% by weight or less, 0.9% by weight or less, 0.85% by weight or less, 0.8% by weight or less, 0.75% by weight or less, 0.7% by weight or less, 0.65% by weight or less, 0.6% by weight or less, 0.55% by weight or less, 0.5% by weight or less, 0.45% by weight or less, 0.4% by weight or less, 0.35% by weight or less, 0.3% by weight or less, 0.25% by weight or less, 0.2% by weight or less, 0.15% by weight or less, 0.1% by weight or less, 0.09% by weight or less, 0.08% by weight or less, 0.07% by weight or less, 0.06% by weight or less, 0.05% by weight or less, 0.04% by weight or less, 0.03% by weight or less, 0.02% by weight or less, 0.01% by weight or less, or 0.005% by weight or less), based on the total weight of the aqueous solution. In particular embodiments, the one or more co-surfactants can have a concentration within the aqueous solution of less than 2%, less than 1.5%, less than 1%, less than 0.5%, less than 0.2%, less than 0.1%, less than 0.075%, less than 0.05%, or less than 0.01%.

When present, the one or more co-surfactants can have a concentration within the aqueous solution ranging from any of the minimum values described above to any of the maximum values described above. For example, in some embodiments, the one or more co-surfactants can have a concentration within the aqueous solution of from 0.001% to 2.5% by weight (e.g., from 0.001% to 1.5% by weight, or from 0.05% to 0.5% by weight), based on the total weight of the aqueous solution.

In some embodiments, the surfactant and one or more co-surfactants can be present in the aqueous solution at a weight ratio of surfactant to one or more co-surfactants of at least 1:1 (e.g., at least 2:1, at least 2.5:1, at least 3:1, at least 4:1, at least 5:1, at least 6:1, at least 7:1, at least 8:1, or at least 9:1). In some embodiments, the surfactant and one or more co-surfactants can be present in the aqueous solution in a weight ratio of surfactant to one or more co-surfactants of 10:1 or less (e.g., 9:1 or less; 8:1 or less, 7:1 or less, 6:1 or less, 5:1 or less, 4:1 or less, 3:1 or less, 2.5:1 or less, or 2:1 or less).

The surfactant and one or more co-surfactants can be present in the aqueous solution in a weight ratio ranging from any of the minimum values described above to any of the maximum values described above. For example, the surfactant and one or more co-surfactants can be present in the aqueous solution in a weight ratio of surfactant to one or more co-surfactants of from 1:1 to 10:1 (e.g., 1:1 to 5:1).

In other embodiments, the one or more co-surfactants are absent (i.e., the surfactant is the only surfactant present in the aqueous solution).

In some embodiments, the total concentration of all surfactants in the aqueous solution (the total concentration of the surfactant and the one or more co-surfactants in the aqueous solution) can be at least 0.01% by weight (e.g., at least 0.02% by weight, at least 0.03% by weight, at least 0.04% by weight, at least 0.05% by weight, at least 0.06% by weight, at least 0.07% by weight, at least 0.08% by weight, at least 0.09% by weight, at least 0.1% by weight, at least 0.15% by weight, at least 0.2% by weight, at least 0.25% by weight, at least 0.3% by weight, at least 0.35% by weight, at least 0.4% by weight, at least 0.45% by weight, at least 0.5% by weight, at least 0.55% by weight, at least 0.6% by weight, at least 0.65% by weight, at least 0.7% by weight, at least 0.75% by weight, at least 0.8% by weight, at least 0.85% by weight, at least 0.9% by weight, at least 0.95% by weight, at least 1% by weight, at least 1.25% by weight, at least 1.5% by weight, at least 1.75% by weight, at least 2% by weight, at least 2.25% by weight, at least 2.5% by weight, at least 2.75% by weight, at least 3% by weight, at least 3.25% by weight, at least 3.5% by weight, at least 3.75% by weight, at least 4% by weight, at least 4.25% by weight, at least 4.5% by weight, or at least 4.75% by weight), based on the total weight of the aqueous solution. In some embodiments, the total concentration of all surfactants in the aqueous solution (the total concentration of the surfactant and the one or more co-surfactants in the aqueous solution) can be 5% by weight or less (e.g., 4.75% by weight or less, 4.5% by weight or less, 4.25% by weight or less, 4% by weight or less, 3.75% by weight or less, 3.5% by weight or less, 3.25% by weight or less, 3% by weight or less, 2.75% by weight or less, 2.5% by weight or less, 2.25% by weight or less, 2% by weight or less, 1.75% by weight or less, 1.5% by weight or less, 1.25% by weight or less, 1% by weight or less, 0.95% by weight or less, 0.9% by weight or less, 0.85% by weight or less, 0.8% by weight or less, 0.75% by weight or less, 0.7% by weight or less, 0.65% by weight or less, 0.6% by weight or less, 0.55% by weight or less, 0.5% by weight or less, 0.45% by weight or less, 0.4% by weight or less, 0.35% by weight or less, 0.3% by weight or less, 0.25% by weight or less, 0.2% by weight or less, 0.15% by weight or less, 0.1% by weight or less, 0.09% by weight or less, 0.08% by weight or less, 0.07% by weight or less, 0.06% by weight or less, 0.05% by weight or less, 0.04% by weight or less, 0.03% by weight or less, or 0.02% by weight or less), based on the total weight of the aqueous solution.

The total concentration of all surfactants in the aqueous solution (the total concentration of the surfactant and the one or more co-surfactants in the aqueous solution) can range from any of the minimum values described above to any of the maximum values described above. For example, in some embodiments, the total concentration of all surfactants in the aqueous solution (the total concentration of the surfactant and the one or more co-surfactants in the aqueous solution) can be from 0.01% by weight to 5% by weight (e.g., from 0.01% to 2.5% by weight, from 0.01% to 1% by weight, or from 0.01% to 0.5% by weight).

In some embodiments, the aqueous solution can include a non-ionic surfactant and an anionic surfactant (e.g., a sulfonate or disulfonate). In some embodiments, the aqueous solution can comprise a non-ionic surfactant and two or more anionic surfactants (e.g., a sulfonate or disulfonate and a carboxylate). In some embodiments, the aqueous solution can comprise a non-ionic surfactant (e.g., a C6-C16 alkyl phenol ethoxylate, or a C6-C16:PO(0-25):EO(0-25), such as a C9-C11 ethoxylated alcohol, a C13 ethoxylated alcohol, a C6-C₁₀ ethoxylated propoxylated alcohol, or a C10-C14 ethoxylated Guerbet alcohol) and a sulfonate surfactant (e.g., a C10-16 disulfonate, or a C16-28 IOS). In some embodiments, the aqueous solution can comprise a non-ionic surfactant (e.g., a C6-C16 alkyl phenol ethoxylate, or a C6-16:PO(0-25):EO(0-25), such as a C9-C11 ethoxylated alcohol, a C13 ethoxylated alcohol, a C6-C₁₀ ethoxylated propoxylated alcohol, or a C10-C14 ethoxylated Guerbet alcohol), a sulfonate surfactant (e.g., a C10-16 disulfonate, or a C16-28 IOS), and a carboxylate surfactant (e.g., a C10-16 alkyl polyglucoside carboxylate or a C22-C36 Guerbet alkoxylated carboxylate).

### Acids

In some embodiments, the aqueous solution can comprise an acid. The acid can comprise any suitable acid known in the art. In some embodiments, the acid can comprise a strong acid, such as HCl. In other embodiments, the acid can comprise a weak acid, such as an organic acid.

In some embodiments, the aqueous solution can have a pH of at least 2 (e.g., at least 2.5, at least 3, at least 3.5, at least 4, at least 4.5, at least 5, or at least 5.5). In some embodiments, the aqueous solution can have a pH of 6 or less (e.g., 5.5 or less, 5 or less, 4.5 or less, 4 or less, 3.5 or less, 3 or less, or 2.5 or less).

The aqueous solution can have a pH ranging from any of the minimum values described above to any of the maximum values described above. For example, in some embodiments, the aqueous solution can have a pH of from 2 to 6 (e.g., from 2 to 5.5, from 2 to 4, or from 2 to 3).

### Alkali Agents

In some embodiments, the aqueous solution can comprise an alkali agent.

The term “alkali agent” is used herein according to its conventional meaning and includes basic, ionic salts of alkali metals or alkaline earth metals. Alkali agents as provided herein are typically capable of reacting with an unrefined petroleum acid (e.g., an acid in crude oil (reactive oil)) to form soap (a surfactant salt of a fatty acid) in situ. These in situ generated soaps serve as a source of surfactants capable of reducing the interfacial tension of hydrocarbons with an aqueous composition. Examples of suitable alkali agents include, but are not limited to, sodium hydroxide, potassium hydroxide, sodium carbonate, potassium carbonate, sodium silicate, sodium metaborate, and salts of EDTA (e.g., EDTA tetrasodium salt or EDTA tetrapotassium salt). In one embodiment, the alkali agent is NaOH. In other embodiments, the alkali agent is Na₂CO₃.

In some embodiments, the aqueous solution can have a pH of at least 8 (e.g., at least 8.5, at least 9, at least 9.5, at least 10, at least 10.5, at least 11, or at least 11.5). In some embodiments, the aqueous solution can have a pH of 12 or less (e.g., 11.5 or less, 11 or less, 10.5 or less, 10 or less, 9.5 or less, 9 or less, or 8.5 or less).

The aqueous solution can have a pH ranging from any of the minimum values described above to any of the maximum values described above. For example, in some embodiments, the aqueous solution can have a pH of from 8 to 12 (e.g., from 8.5 to 12, from 9 to 12, from 8.5 to 11.5, from 9 to 11.5, from 8.5 to 11, or from 9 to 11).

### Co-Solvents

In some embodiments, the aqueous solution can comprise a co-solvent.

Suitable co-solvents include alcohols, such as lower carbon chain alcohols such as isopropyl alcohol, ethanol, n-propyl alcohol, n-butyl alcohol, sec-butyl alcohol, n-amyl alcohol, sec-amyl alcohol, n-hexyl alcohol, sec-hexyl alcohol and the like; alcohol ethers, polyalkylene alcohol ethers, polyalkylene glycols, poly(oxyalkylene)glycols, poly(oxyalkylene)glycol ethers, ethoxylated phenol, or any other common organic co-solvent or combinations of any two or more co-solvents. In one embodiment, the co-solvent can comprise alkyl ethoxylate (C1-C6)-XEO X=1-30-linear or branched. In some embodiments, the co-solvent can comprise ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), diethylene glycol, polyethylene glycol (PEG), or any combination thereof. In some embodiments, the co-solvent can comprise ethylene glycol butyl ether (EGBE) and diethylene glycol.

In some embodiments, the co-solvent can be present in the aqueous solution in an amount of 0.01% or more by weight, based on total weight of the aqueous solution (e.g., 0.05% or more, 0.1% or more, 0.15% or more, 0.2% or more, 0.25% or more, 0.3% or more, 0.35% or more, 0.4% or more, 0.45% or more, 0.5% or more, 0.6% or more, 0.7% or more, 0.8% or more, 0.9% or more, 1% or more, 1.25% or more, 1.5% or more, 1.75% or more, 2% or more, 2.5% or more, 3% or more, 3.5% or more, 4% or more, 4.5% or more, 5% or more, 5.5% or more, 6% or more, 6.5% or more, 7% or more, 7.5% or more, 8% or more, 8.5% or more, 9% or more, 9.5% or more, 10% or more, 11% or more, 12% or more, 13% or more, 14% or more, 15% or more, 16% or more, 17% or more, 18% or more, 19% or more, 20% or more, 21% or more, 22% or more, 23% or more, or 24% or more). In some embodiments, the co-solvent can be present in the aqueous solution in an amount of 25% or less by weight, based on total weight of the aqueous solution (e.g., 24% or less, 23% or less, 22% or less, 21% or less, 20% or less, 19% or less, 18% or less, 17% or less, 16% or less, 15% or less, 14% or less, 13% or less, 12% or less, 11% or less, 10% or less, 9.5% or less, 9% or less, 8.5% or less, 8% or less, 7.5% or less, 7% or less, 6.5% or less, 6% or less, 5.5% or less, 5% or less, 4.5% or less, 4% or less, 3.5% or less, 3% or less, 2.5% or less, 2% or less, 1.75% or less, 1.5% or less, 1.25% or less, 1% or less, 0.9% or less, 0.8% or less, 0.7% or less, 0.6% or less, 0.5% or less, 0.45% or less, 0.4% or less, 0.35% or less, 0.3% or less, 0.25% or less, 0.2% or less, 0.15% or less, or 0.1% or less). The amount of co-solvent present can range from any of the minimum values described above to any of the maximum values described above. In some embodiments, the co-solvent can be present in the aqueous solution in an amount of from 0.01% to 25% by weight, based on the total weight of the aqueous solution (e.g., from 0.01% to 20%, from 0.01% to 15%, from 0.01% to 10%, from 0.01% to 5%, from 0.01% to 1%, from 0.01% to 0.7%, from 0.25% to 0.7%, from 0.1% to 25%, from 0.1% to 10%, or from 0.5% to 5%).

### Viscosity-Modifying Polymers

In some embodiments, the aqueous solution can include a viscosity-modifying polymer. Examples of viscosity-modifying polymer are known in the art. Examples of suitable polymers include biopolymers such as polysaccharides. For example, polysaccharides can be xanthan gum, scleroglucan, guar gum, a mixture thereof (e.g., any modifications thereof such as a modified chain), etc. Indeed, the terminology “mixtures thereof” or “combinations thereof” can include “modifications thereof” herein. Examples of suitable synthetic polymers include polyacrylamides. Examples of suitable polymers include synthetic polymers such as partially hydrolyzed polyacrylamides (HPAMs or PHPAs) and hydrophobically-modified associative polymers (APs). Also included are co-polymers of polyacrylamide (PAM) and one or both of 2-acrylamido 2-methylpropane sulfonic acid (and/or sodium salt) commonly referred to as AMPS (also more generally known as acrylamido tertiobutyl sulfonic acid or ATBS), N-vinyl pyrrolidone (NVP), and the NVP-based synthetic may be single-, co-, or ter-polymers. In one embodiment, the synthetic polymer is polyacrylic acid (PAA). In one embodiment, the synthetic polymer is polyvinyl alcohol (PVA). Copolymers may be made of any combination or mixture above, for example, a combination of NVP and ATBS.

In certain embodiments, the viscosity-modifying polymer can comprise a biopolymer. In certain embodiments, the viscosity-modifying polymer can comprise a polysaccharide. In certain embodiments, the viscosity modifying polymer can comprise xanthan gum.

In certain embodiments, the viscosity-modifying polymer can comprise an uncrosslinked polymer.

In some embodiments, the viscosity-modifying polymer can be present in the aqueous solution in an amount of 0.01% or more by weight, based on total weight of the aqueous solution (e.g., 0.05% or more, 0.1% or more, 0.15% or more, 0.2% or more, 0.25% or more, 0.3% or more, 0.35% or more, 0.4% or more, 0.45% or more, 0.5% or more, 0.6% or more, 0.7% or more, 0.8% or more, 0.9% or more, 1% or more, 1.25% or more, 1.5% or more, 1.75% or more, 2% or more, 2.5% or more, 3% or more, 3.5% or more, 4% or more, 4.5% or more, 5% or more, 5.5% or more, 6% or more, 6.5% or more, 7% or more, 7.5% or more, 8% or more, 8.5% or more, 9% or more, 9.5% or more, 10% or more, 11% or more, 12% or more, 13% or more, 14% or more, 15% or more, 16% or more, 17% or more, 18% or more, 19% or more, 20% or more, 21% or more, 22% or more, 23% or more, or 24% or more). In some embodiments, the viscosity-modifying polymer can be present in the aqueous solution in an amount of 25% or less by weight, based on total weight of the aqueous solution (e.g., 24% or less, 23% or less, 22% or less, 21% or less, 20% or less, 19% or less, 18% or less, 17% or less, 16% or less, 15% or less, 14% or less, 13% or less, 12% or less, 11% or less, 10% or less, 9.5% or less, 9% or less, 8.5% or less, 8% or less, 7.5% or less, 7% or less, 6.5% or less, 6% or less, 5.5% or less, 5% or less, 4.5% or less, 4% or less, 3.5% or less, 3% or less, 2.5% or less, 2% or less, 1.75% or less, 1.5% or less, 1.25% or less, 1% or less, 0.9% or less, 0.8% or less, 0.7% or less, 0.6% or less, 0.5% or less, 0.45% or less, 0.4% or less, 0.35% or less, 0.3% or less, 0.25% or less, 0.2% or less, 0.15% or less, or 0.1% or less). The amount of viscosity-modifying polymer present can range from any of the minimum values described above to any of the maximum values described above. In some embodiments, the viscosity-modifying polymer can be present in the aqueous solution in an amount of from 0.01% to 25% by weight, based on the total weight of the aqueous solution (e.g., from 0.01% to 20%, from 0.01% to 15%, from 0.01% to 10%, from 0.01% to 5%, from 0.01% to 1%, from 0.01% to 0.5%, from 0.01% to 0.25%, from 0.1% to 25%, from 0.1% to 10%, or from 0.5% to 5% by weight).

### Foam Stabilizers

In some embodiments, the aqueous solution can further comprise a foam stabilizer. Foam stabilizers are known in the art and include, for example, crosslinkers, particulate stabilizers, or any combination thereof.

In some embodiments, the aqueous solution can further include a crosslinker, such as a borate crosslinking agent, a Zr crosslinking agent, a Ti crosslinking agent, an Al crosslinking agent, an organic crosslinker, or any combination thereof. In some examples, the foam stabilizer can comprise a crosslinker and the viscosity-modifying polymer and the crosslinker can be present in a weight ratio of 10:1 or more (e.g., 15:1 or more, 20:1 or more, 25:1 or more, 30:1 or more, 35:1 or more, 40:1 or more, 45:1 or more, 50:1 or more, 55:1 or more, 60:1 or more, 65:1 or more, 70:1 or more, 75:1 or more, 80:1 or more, 85:1 or more, or 90:1 or more). In some examples, the viscosity-modifying polymer and the crosslinker can be present in a weight ratio of 100:1 or less (e.g., 95:1 or less, 90:1 or less, 85:1 or less, 80:1 or less, 75:1 or less, 70:1 or less, 65:1 or less, 60:1 or less, 55:1 or less, 50:1 or less, 45:1 or less, 40:1 or less, 35:1 or less, 30:1 or less, 25:1 or less, or 20:1 or less). The weight ratio at which the viscosity-modifying polymer and the crosslinker are present can range from any of the minimum values described above to any of the maximum values described above. For example, the viscosity-modifying polymer and the crosslinker can be present in a weight ratio of from 10:1 to 100:1 (e.g., from 10:1 to 55:1, from 55:1 to 100:1, from 10:1 to 40:1, from 40:1 to 70:1, from 70:1 to 100:1, from 20:1 to 100:1, from 10:1 to 90:1, from 20:1 to 90:1, from 10:1 to 75:1, or from 25:1 to 50:1).

In some embodiments, the aqueous solution can further include a particulate stabilizer (e.g., nanoparticles or microparticles). Examples of suitable nanoparticles and microparticles are known in the art, and include, for example, nickel oxide, alumina, silica (surface-modified), a silicate, iron oxide (Fe₃O₄), titanium oxide, impregnated nickel on alumina, synthetic clay, natural clay, iron zinc sulfide, magnetite, iron octanoate, or any combination thereof. In some examples, the aqueous solution can further include a particulate stabilizer comprising a synthetic clay, a natural clay, or any combination thereof, such as attapulgite, bentonite, or any combination thereof. Other examples of suitable nanoparticles are described, for example, in U.S. Pat. No. 10,266,750, which is hereby incorporated by reference in its entirety.

In some examples, the aqueous solution can include a particulate stabilizer having an average particle size of 100 nanometers (nm) or more (e.g., 200 nm or more, 300 nm or more, 400 nm or more, 500 nm or more, 750 nm or more, 1 micrometer (micron, μm) or more, 2 μm or more, 3 μm or more, 4 μm or more, 5 μm or more, 10 μm or more, 15 μm or more, or 20 μm or more). In some examples, the particulate stabilizer can have an average particle size of 25 μm or less (e.g., 20 μm or less, 15 μm or less, 10 μm or less, 5 μm or less, 4 μm or less, 3 μm or less, 2 μm or less, 1 μm or less, 750 nm or less, 500 nm or less, 400 nm or less, or 300 nm or less). The average particle size of the particulate stabilizer can range from any of the minimum values described above to any of the maximum values described above. For example, the particulate stabilizer can have an average particle size of from 100 nm to 25 μm (e.g., from 100 nm to 10 μm, from 100 nm to 5 μm, from 100 nm to 100 μm, from 100 μm to 500 μm, from 100 nm to 200 μm, from 100 nm to 150 μm, from 100 nm to 100 μm, from 100 nm to 50 μm, or from 100 nm to 10μ m).

In some embodiments, the foam stabilizer can be present in the aqueous solution in an amount of 0.01% or more by weight, based on total weight of the aqueous solution (e.g., 0.05% or more, 0.1% or more, 0.15% or more, 0.2% or more, 0.25% or more, 0.3% or more, 0.35% or more, 0.4% or more, 0.45% or more, 0.5% or more, 0.6% or more, 0.7% or more, 0.8% or more, 0.9% or more, 1% or more, 1.25% or more, 1.5% or more, 1.75% or more, 2% or more, 2.5% or more, 3% or more, 3.5% or more, 4% or more, 4.5% or more, 5% or more, 5.5% or more, 6% or more, 6.5% or more, 7% or more, 7.5% or more, 8% or more, 8.5% or more, or 9% or more). In some embodiments, the foam stabilizer can be present in an amount of 10% or less by weight, based on total weight of the aqueous solution (e.g., 9.5% or less, 9% or less, 8.5% or less, 8% or less, 7.5% or less, 7% or less, 6.5% or less, 6% or less, 5.5% or less, 5% or less, 4.5% or less, 4% or less, 3.5% or less, 3% or less, 2.5% or less, 2% or less, 1.75% or less, 1.5% or less, 1.25% or less, 1% or less, 0.9% or less, 0.8% or less, 0.7% or less, 0.6% or less, 0.5% or less, 0.45% or less, 0.4% or less, 0.35% or less, 0.3% or less, 0.25% or less, 0.2% or less, 0.15% or less, or 0.1% or less). The amount of foam stabilizer present in the aqueous solution can range from any of the minimum values described above to any of the maximum values described above. For example, the foam stabilizer can be present in the aqueous solution in an amount of from 0.01% to 10% by weight, based on total weight of the aqueous solution (e.g., from 0.01% to 5%, from 5% to 10%, from 0.01% to 2%, from 2% to 4%, from 4% to 6%, from 6% to 8%, from 8% to 10%, from 0.01% to 8%, from 1% to 10%, from 1% to 8%, from 1.5% to 3.5%, from 2% to 3%, or from 0.01% to 2.5%).

### Breakers

In some embodiments, the aqueous solution can further comprise a breaker. In some embodiments, the aqueous solution can further comprise an oxidizer to break the polymer. In certain embodiments, the period of time in step (c) comprises a period of time effective to allow the aqueous solution to break.

### EXAMPLE EMBODIMENTS

Certain example implementations are described in the embodiments below.
Embodiment 1: A method for hydrocarbon recovery from an unconventional subterranean formation having a wellbore in fluid communication therewith, the method comprising:
injecting a volume of an aqueous solution through the wellbore into the unconventional subterranean formation between injections of a volume of a first gas and a volume of a second gas through the wellbore into the unconventional subterranean formation; and
producing fluids from the unconventional subterranean formation through the wellbore;
wherein a sum of the volume of the first gas and the volume of the second gas equals to a total gas volume; and
wherein a ratio of the total gas volume (in SCF) to the volume of the aqueous solution (in BBL) is from 1,750:1 to 10,000:1.
Embodiment 2: The method of embodiment 1, wherein the total gas volume is at least 100 million SCF.
Embodiment 3: The method of embodiment 1, wherein the total gas volume is of from 100 million SCF to 750 million SCF.
Embodiment 4: The method of any one of embodiments 1-2, wherein the first gas and the second gas are present in a ratio of the first gas to the second gas of from 0.25:1 to 1.5:1 (e.g., from 0.5:1 to 1.5:1, from 0.5:1 to 1:1, or from 1:1 to 1.5:1).
Embodiment 5: The method of any one of embodiments 1-4, wherein the volume of the aqueous solution injected is from 5% of the estimated stimulated reservoir volume (SRV) to 70% of the estimated SRV (e.g., from 10% of the estimated SRV to 70% of the estimated SRV).
Embodiment 6: The method of any one of embodiments 1-5, wherein the volume of the aqueous solution is injected in a volume of least 20,000 barrels.
Embodiment 7: The method of any one of embodiments 1-6, wherein the volume of the aqueous solution is injected in a volume of from 20,000 barrels to 150,000 barrels.
Embodiment 8: The method of any one of embodiments 1-7, wherein the aqueous solution comprises water.
Embodiment 9: The method of any one of embodiments 1-8, wherein the aqueous solution further comprises a surfactant.
Embodiment 10: The method of embodiment 9, wherein the surfactant comprises a non-ionic surfactant, an anionic surfactant, or any combination thereof.
Embodiment 11: The method of any one of embodiments 1-10, wherein the aqueous solution further comprises an acid, an alkali agent, a co-solvent, a co-surfactant, a foam stabilizer, a viscosity modifying polymer, a chelating agent (e.g., EDTA or a salt thereof), a clay swelling inhibitor (e.g., KCl), a biocide, a scale inhibitor, a breaker, a corrosion inhibitor, a sulfide scavenger, or any combination thereof.
Embodiment 12: The method of any one of embodiments 1-11, wherein the gas comprises nitrogen, natural gas or a hydrocarbon component thereof, helium, CO₂, H₂S, air, or any combination thereof.
Embodiment 13: The method of embodiment 12, wherein the gas comprises methane, ethane, propane, butane, or any combination thereof.
Embodiment 14: The method of embodiment 13, wherein the gas comprises natural gas enriched with propane, butane, or any combination thereof.
Embodiment 15: A method for hydrocarbon recovery from an unconventional subterranean formation having a wellbore in fluid communication therewith, the method comprising:
   co-injecting a volume of an aqueous solution and a volume of a gas through the wellbore into the unconventional subterranean formation; and
   producing fluids from the unconventional subterranean formation through the wellbore;
   wherein a ratio of the volume of the gas (in SCF) to the volume of the aqueous solution (in BBL) is from 1,750:1 to 10,000:1.
Embodiment 16: The method of embodiment 15, wherein the gas volume is at least 100 million SCF.
Embodiment 17: The method of embodiment 15 or embodiment 16, wherein the gas volume is of from 100 million SCF to 750 million SCF.
Embodiment 18: The method of any one of embodiments 15-17, wherein the volume of the aqueous solution co-injected is from 5% of the estimated SRV to 70% of the estimated SRV.
Embodiment 19: The method of any one of embodiments 15-18, wherein the volume of the aqueous solution is co-injected in a volume of least 20,000 barrels.
Embodiment 20: The method of any one of embodiments 15-19, wherein the volume of the aqueous solution is co-injected in a volume of from 20,000 barrels to 150,000 barrels.
Embodiment 21: The method of any one of embodiments 15-20, wherein the aqueous solution comprises water.
Embodiment 22: The method of any one of embodiments 15-21, wherein the aqueous solution further comprises a surfactant.
Embodiment 23: The method of embodiment 22, wherein the surfactant comprises a non-ionic surfactant, an anionic surfactant, or any combination thereof.
Embodiment 24: The method of any one of embodiments 15-23, wherein the aqueous solution further comprises an acid, an alkali agent, a co-solvent, a co-surfactant, a foam stabilizer, a viscosity modifying polymer, a chelating agent (e.g., EDTA or a salt thereof), a clay swelling inhibitor (e.g., KCl), a biocide, a scale inhibitor, a breaker, a corrosion inhibitor, a sulfide scavenger, or any combination thereof.
Embodiment 25: The method of any one of embodiments 15-24, wherein the gas comprises nitrogen, natural gas or a hydrocarbon component thereof, helium, CO₂, H₂S, air, or any combination thereof.
Embodiment 26: The method of any one of embodiments 15-25, wherein the gas comprises methane, ethane, propane, butane, or any combination thereof.
Embodiment 27: The method of any one of embodiments 15-26, wherein the gas comprises natural gas enriched with propane, butane, or any combination thereof.
Embodiment 28: A method for hydrocarbon recovery from an unconventional subterranean formation having a wellbore in fluid communication therewith, the method comprising:
   injecting a volume of a first gas through the wellbore into the unconventional subterranean formation;
   co-injecting a volume of an aqueous solution and a volume of a second gas through the wellbore into the unconventional subterranean formation; and
   producing fluids from the unconventional subterranean formation through the wellbore;
   wherein a sum of the volume of the first gas and the volume of the second gas equals to a total gas volume; and
   wherein a ratio of the total gas volume (in SCF) to the volume of the aqueous solution (in BBL) is from 1,750:1 to 10,000:1.
Embodiment 29: The method of embodiment 28, wherein the total gas volume is at least 100 million SCF.
Embodiment 30: The method of embodiment 28 or 29, wherein the total gas volume is of from 100 million SCF to 750 million SCF.
Embodiment 31: The method of any one of embodiments 28-30, wherein the first gas and the second gas are present in a ratio of the first gas to the second gas of from 0.25:1 to 1.5:1 (e.g., from 0.5:1 to 1.5:1, from 0.5:1 to 1:1, or from 1:1 to 1.5:1).
Embodiment 32: The method of any one of embodiments 28-31, wherein the volume of the aqueous solution co-injected is from 5% of the estimated SRV to 70% of the estimated SRV (e.g., from 10% of the estimated SRV to 70% of the estimated SRV).
Embodiment 33: The method of any one of embodiments 28-32, wherein the volume of the aqueous solution is co-injected in a volume of least 20,000 barrels.
Embodiment 34: The method of any one of embodiments 28-33, wherein the volume of the aqueous solution is co-injected in a volume of from 20,000 barrels to 150,000 barrels.
Embodiment 35: The method of any one of embodiments 28-34, wherein the aqueous solution comprises water.
Embodiment 36: The method of any one of embodiments 28-35, wherein the aqueous solution further comprises a surfactant.
Embodiment 37: The method of embodiment 36, wherein the surfactant comprises a non-ionic surfactant, an anionic surfactant, or any combination thereof.
Embodiment 38: The method of any one of embodiments 28-37, wherein the aqueous solution further comprises an acid, an alkali agent, a co-solvent, a co-surfactant, a foam stabilizer, a viscosity modifying polymer, a chelating agent (e.g., EDTA or a salt thereof), a clay swelling inhibitor (e.g., KCl), a biocide, a scale inhibitor, a breaker, a corrosion inhibitor, a sulfide scavenger, or any combination thereof.
Embodiment 39: The method of any one of embodiments 28-38, wherein the gas comprises nitrogen, natural gas or a hydrocarbon component thereof, helium, CO₂, H₂S, air, or any combination thereof.
Embodiment 40: The method of any one of embodiments 28-39, wherein the gas comprises methane, ethane, propane, butane, or any combination thereof.
Embodiment 41: The method of any one of embodiments 28-40, wherein the gas comprises natural gas enriched with propane, butane, or any combination thereof.
Embodiment 42: The method of any one of embodiments 1-41, wherein the method further comprises allowing the aqueous solution to contact a rock matrix of the unconventional subterranean formation for a period of time.
Embodiment 43: The method of any of embodiments 1-42, wherein the method comprises forming an aqueous based foam in situ within the wellbore.
Embodiment 44: The method of any one of embodiments 1-43, wherein the aqueous based foam provides for conformance control.
Embodiment 45: The method of any one of embodiments 1-44, wherein the method increases hydrocarbon recovery from the wellbore as compared to an expected level of hydrocarbon recovery projected from a decline curve fit to production history of the wellbore, such as using Arp's Equation.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

By way of non-limiting illustration, examples of certain embodiments of the present disclosure are given below.

### EXAMPLES

### Example 1

The cyclic water alternating gas for tight rocks process can involve the injection of a water slug in the middle of two gas slugs instead of injecting the whole gas slug at a time unlike it was done previously. The injected water traps the injected gas by reducing the relative permeability of the injected gas. Since the gas is trapped it does not flow back as easily as compared to a simple cyclic gas injection. Thus, the injected gas remains longer in the reservoir and mixes with the reservoir oil in a much better way. Thus, the oil mobility increase is much better compared to the simple cyclic gas injection and there by the oil recovery is also better.

A test well underwent a Cyclic Water Alternating Gas for Tight Rocks process. Approximately 150 MMSCF of hydrocarbon gas (produced gas) was injected with approximately 20,000 BBL of water in the middle of the gas slug. During the following production cycle, high and sustained oil rates were observed for months. The produced gas rates were much lower compared to the ones observed after simple cyclic gas injection cycles performed earlier in the same well. Suggesting that the injected gas was indeed trapped by the water slug.

The Cyclic Water Alternating Gas for Tight Rocks process can be used to improve recovery of shale and tight wells, including wells that have been producing for a long time (e.g., >4 years). This can increase the oil production without drilling new wells. In some embodiments, the method can include adding a surfactant to the water.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A method for hydrocarbon recovery from an unconventional subterranean formation having a wellbore in fluid communication therewith, the method comprising:
injecting a volume of an aqueous solution through the wellbore into the unconventional subterranean formation between injections of a volume of a first gas and a volume of a second gas through the wellbore into the unconventional subterranean formation;
wherein a sum of the volume of the first gas and the volume of the second gas equals to a total gas volume; and
wherein a ratio of the total gas volume (in SCF) to the volume of the aqueous solution (in BBL) is from 1,750:1 to 10,000:1.

2. The method of claim 1, wherein the total gas volume is at least 100 million SCF.

3. The method of claim 1, wherein the total gas volume is of from 100 million SCF to 750 million SCF.

4. The method of claim 1, wherein the first gas and the second gas are present in a ratio of the first gas to the second gas of from 0.25:1 to 1.5:1 (e.g., from 0.5:1 to 1.5:1, from 0.5:1 to 1:1, or from 1:1 to 1.5:1).

5. The method of claim 1, wherein the volume of the aqueous solution injected is from 5% of the estimated stimulated reservoir volume (SRV) to 70% of the estimated SRV (e.g., from 10% of the estimated SRV to 70% of the estimated SRV).

6. The method of claim 1, wherein the volume of the aqueous solution is injected in a volume of least 20,000 barrels.

7. The method of claim 1, wherein the volume of the aqueous solution is injected in a volume of from 20,000 barrels to 150,000 barrels.

8. The method of claim 1, wherein the aqueous solution comprises water.

9. The method of claim 1, wherein the aqueous solution further comprises a surfactant.

10. The method of claim 9, wherein the surfactant comprises a non-ionic surfactant, an anionic surfactant, or any combination thereof.

11. The method of claim 1, wherein the aqueous solution further comprises an acid, an alkali agent, a co-solvent, a co-surfactant, a foam stabilizer, a viscosity modifying polymer, a chelating agent (e.g., EDTA or a salt thereof), a clay swelling inhibitor (e.g., KCl), a biocide, a scale inhibitor, a breaker, a corrosion inhibitor, a sulfide scavenger, or any combination thereof.

12. The method of claim 1, wherein the gas comprises nitrogen, natural gas or a hydrocarbon component thereof, helium, CO₂, H₂S, air, or any combination thereof.

13. The method of claim 12, wherein the gas comprises methane, ethane, propane, butane, or any combination thereof.

14. The method of claim 13, wherein the gas comprises natural gas enriched with propane, butane, or any combination thereof.

15. The method of claim 1, wherein the method further comprises allowing the aqueous solution to contact a rock matrix of the unconventional subterranean formation for a period of time.

16. The method of claim 1, wherein the method comprises forming an aqueous based foam in situ within the wellbore.

17. The method of claim 1, wherein the aqueous based foam provides for conformance control.

18. The method of claim 1, wherein the method further comprises producing fluids from the unconventional subterranean formation through the wellbore.

19. A method for hydrocarbon recovery from an unconventional subterranean formation having a wellbore in fluid communication therewith, the method comprising:
co-injecting a volume of an aqueous solution and a volume of a gas through the wellbore into the unconventional subterranean formation;
wherein a ratio of the volume of the gas (in SCF) to the volume of the aqueous solution (in BBL) is from 1,750:1 to 10,000:1.

20. A method for hydrocarbon recovery from an unconventional subterranean formation having a wellbore in fluid communication therewith, the method comprising:
injecting a volume of a first gas through the wellbore into the unconventional subterranean formation; and
co-injecting a volume of an aqueous solution and a volume of a second gas through the wellbore into the unconventional subterranean formation;
wherein a sum of the volume of the first gas and the volume of the second gas equals to a total gas volume; and
wherein a ratio of the total gas volume (in SCF) to the volume of the aqueous solution (in BBL) is from 1,750:1 to 10,000:1.
